(19) United States
(12) Patent Application Publication
(10) Pub. No.: US 2008/0288331 A1
(43) Pub. Date: Nov. 20, 2008

(54) SYSTEM AND METHOD FOR ANALYSIS AND VISUAL REPRESENTATION OF BRAND PERFORMANCE INFORMATION

(76) Inventors: Scott Magids, Rockville, MD (US); Alan Zorfas, Westport, CT (US); Scott Laughlin, Vienna, VA (US)

Correspondence Address: DLA PIPER US LLP, P. O. BOX 9271, RESTON, VA, 20195, US

(21) Appl. No.: 12/121,887

(22) Filed: May 16, 2008

Related U.S. Application Data
(60) Provisional application No. 60/938,758, filed on May 18, 2007.

(51) Int. Cl. G06F 17/00

(52) U.S. Cl. 705/10

(57) ABSTRACT

A method of, and system for, measuring performance of a brand comprises: receiving, from a plurality of responders, responses to a set of survey questions, the set of survey questions comprising n subsets of questions, n being an integer, each of the n subsets of survey questions being intended to measure respectively corresponding one n attributes of the brand; assigning, for each of said n attributes, a score based on responses to respective corresponding one of the n subsets of questions, wherein said n attributes comprises: a connection attribute relating to perceived quality associated with the measured brand, and a loyalty attribute relating to loyalty towards the brand.

### CROSS-REFERENCE TO RELATED APPLICATIONS

This application claims the benefit of U.S. Provisional Application No. 60/938,758, filed on May 18, 2007, the disclosure of which is incorporated herein by reference in its entirety.

### FIELD OF THE INVENTION

The present invention is directed to a computer system and method of operation of a computer system that can assess and analyze the performance strength of brand names, and more specifically relates to such a computer system that uses unique metrics and indices for qualitative analysis of a brand name, and to the presentation of the result of the analysis.

### BRIEF DESCRIPTION OF THE DRAWINGS

A preferred embodiment of the invention as well as alternate embodiments are described by way of example with reference to the accompanying drawings in which like numbers correspond to like elements, and in which:

FIG. 1 is a block diagram of an example computer network usable in practicing embodiments of the present invention;

FIG. 2 is a block diagram showing the relevant portions of a brand benchmarking server according to an embodiment of the invention;

FIG. 3 is a flow diagram illustrating the four broad categories of tasks performed during brand performance analysis according to an embodiment of the invention;

FIG. 4 is a flow diagram illustrating the data collection procedure according to an embodiment of the invention;

FIG. 5 illustrates the dimensions included in the Brand Relationship Model according to an embodiment of the invention;

FIGS. 6A-6C illustrates the visual representation of the range of Pricing Power attribute in the Brand Relationship Model according to an embodiment of the invention;

FIG. 7 illustrates an example of a completed Brand Relationship Model according to an embodiment of the invention;

FIG. 8 illustrates an example of a side-by-side display of Brand Relationship Models for a brand and the industry;

FIG. 9 illustrates an example of the relative modeling of multiple industry brands;

FIG. 10 illustrates an example of side-by-side display of several competitive brands; and

FIGS. 11 and 12 illustrate examples of changes in brand performance over time.

### DETAILED DESCRIPTION OF THE SEVERAL EMBODIMENTS

Reference will now be made in detail to the embodiments of the present invention, examples of which are illustrated in the accompanying drawings, wherein like reference numerals refer to like elements throughout.

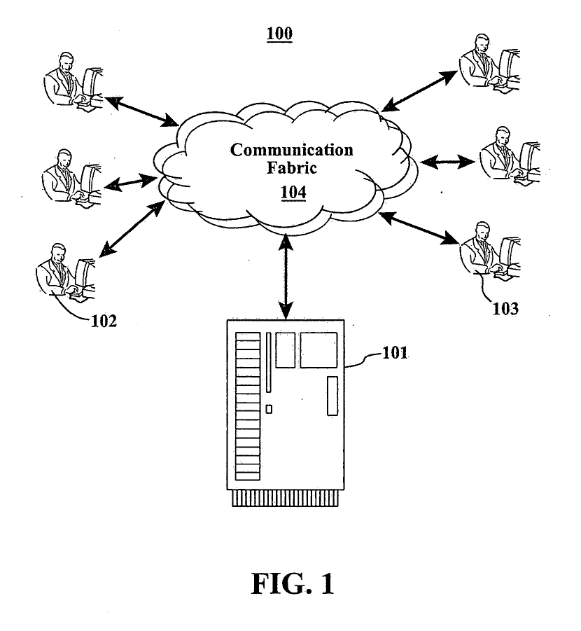

The methods for measuring and scoring the performance of a brand, for benchmarking a brand, and for visualizing a brand's strength described herein may be practiced utilizing a computer network. An example of such computer network is illustrated in FIG. 1. As shown, the computer network 100 may comprise an interconnect fabric 104, through which each of the survey participants 102, the brand benchmarking server 101 and the brand information users 103 communicate with each other. The communication fabric 104 may be a wide area network (WAN), and may comprise a plurality of computers, routers, gateways and/or portions of the Public Switched Telephone Network (PSTN), as known to those familiar with the architecture of wide area networks, e.g., the Internet.

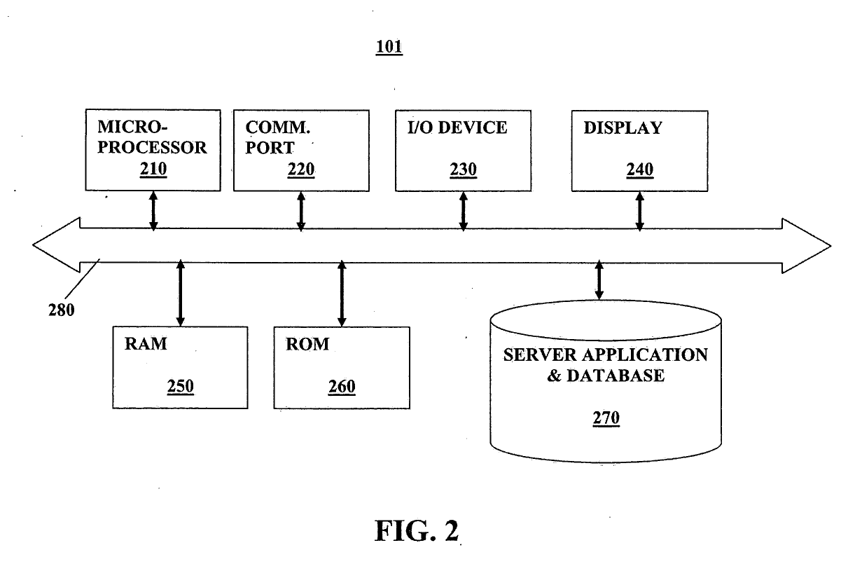

The brand benchmarking server 101 may collect survey responses from the survey participants 102 through the communication fabric 104, performs the benchmarking of brand(s) based on the survey responses, and may provide the result of the benchmarking to the brand information users 103. The brand benchmarking server 101 may be a computer, such as including, e.g., a personal computer (PC), a main frame computer or the like. An example of such computer is shown in FIG. 2.

For example, the brand benchmarking server 101 may include microprocessor 210 in communication with bus 280. Microprocessor 210 may be a Pentium™, RISC™-based, or other type of processor and is used to execute processor-executable process steps so as to control the components of the brand benchmarking server 101 to provide desired functionality.

Also in communication with bus 280 is communication port 220. The communication port 220 may be used to transmit data to and to receive data from the communication fabric 104. In one embodiment, the communication port 230 may be a modem, Ethernet device, or a TCP/IP communications device or the like.

The I/O device 230 and the display 240 may also be in communication with the bus 280. The I/O device may be any known human-to-computer interface device, including a keyboard, mouse, touch pad, voice-recognition system, or any combination of these devices. The I/O device 230 may be used by an operator of the brand benchmarking server 101 to input commands or data. The display 240 may be an integral or separate CRT display, flat-panel display or the like. The display 240 may be used to output graphics and text to an operator of the brand benchmarking server 101.

The random access memory (RAM) 250 may be connected to bus 280 to provide microprocessor 210 with data storage during operation. The read-only-memory (ROM) 260 provides a pseudo permanent storage that is not erased even when the power to the brand benchmarking server 101 is removed. The ROM 260 may also store the instructions to be executed by the microprocessor 210.

Data storage device 270 stores, among other data, processor-executable process steps of the brand benchmarking server 101. Microprocessor 210 may execute instructions of brand benchmarking server 101 to cause brand benchmarking server 101 to operate in accordance with the process steps described in detail herein. The data storage 270 may also included processor-executable process steps to cause the brand benchmarking server 101 to operate as a World Wide Web server.

Also, a database of survey response data, collected in the manner described in detail herein, may be stored in data storage device 270.

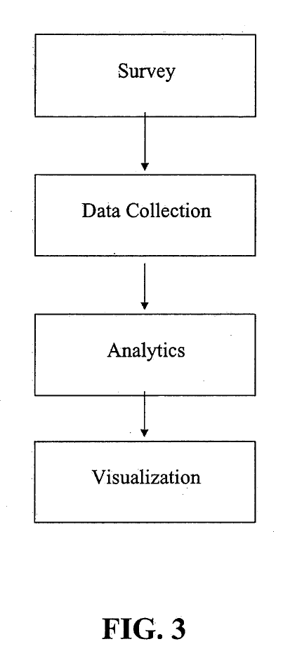

Embodiments of the novel methods for measuring and visualizing the performance of a brand will now be described in detail. The method, which may be implemented in the brand benchmarking server 101, may include the four broad categories of tasks shown in FIG. 3. While in the described embodiment each of the four categories are implemented by the brand benchmarking server 101, some of or all of the categories may be implemented by separate server(s).

### Survey

A survey may be conducted to gather data used to determine the unique metrics, indices, benchmarks and graphical representation of the benchmarks. An example of a process by which a survey may be developed and validated is described below.

A battery of survey questionnaires may be developed as the initial battery of statements (“Original Statements”). An example of a set of Original Statements are appended hereto in APPENDIX A. Statements exist for each element of the Brand Relationship Model (as hereinafter further defined).

The Original Statements may include, according to the Brand Relationship Model, a number of survey statements indicative of the four attributes: “Connection,” “Loyalty,” “Experience” and “Pricing Power.”

Connection statements: Possible statements may be developed to measure how customers feel about, or connect with, the brands, and may include the following sub Connection attribute statements: 1) Transformation Connection (“TC”): an initial battery of statements (see statements numbered with a “T” on APPENDIX A) may be developed to measure the degree to which a customer's life is affected and improved by a brand; 2) Enhancement Connection (“EC”): an initial battery of statements (see statements numbered with an “En” on APPENDIX A) may be developed to measure a customer's perception of a brand's unique and superior benefits and attributes; 3) Expectation Connection (“XC”): an initial battery of statements (see statements numbered with an “Ex” on APPENDIX A) may be developed to measure the degree to which a brand satisfies a customer's expectations—such as the expected quality; and 4) Assumption Connection (“AC”): An initial battery of statements (see statements numbered with an “A” on APPENDIX A) may be developed to measure the degree to which a brand satisfies a customer's assumptions—such as trust and safety.

Loyalty statements. Statements may be developed to measure the commitments, intentions to purchase and the overall loyalty towards a brand of customers (see APPENDIX A; statements beginning with “L”).

Experience statements. Statements may be developed to measure experiences (either positive or negative) of customers with respect a brand were developed (see APPENDIX A; statements beginning with “X”).

Pricing Power measure. A scale may be developed to measure pricing power. An average price is described for comparable products and services in the industry, and customers may be asked to move a scale right or left of average to assess price (see APPENDIX A).

In addition to the above four attribute related survey statements, each survey may additionally contain demographic profiling type of questions. For example, the ten (10) demographic profiling questions used in this example are listed in APPENDIX E. Collecting demographic information may enable the assessment of the brand performance across demographic segments.

As also included in APPENDIX E, each survey may additionally contain questions concerning customers' use history, use breadth and use duration of the brand. This information may enable the assessment of the brand performance across usage groups.

Validation of the initial statements may also be conducted. To validate the predictiveness of the initial Connection and Loyalty statements, and to select permanent statements (the “Final Statements” defined to include the final Connection and Loyalty statements, as described below, and the Experience statements, set forth on APPENDIX D, and Pricing Power measure, set forth on APPENDIX D) to use in all ongoing studies, the following process, which may be implemented by the brand benchmarking server 101, may be followed:

First, a large number of respondents may be interviewed, e.g., from the survey participants 102 through the communication fabric 104. In the example being described, an on-line interviews of 12,000 respondents about 80 diverse brands in 20 industries, asking each person the full battery of Connection, Loyalty and Experience statements, as well as the Pricing Power measure, all listed in APPENDIX A, may be conducted. APPENDIX B lists the brands studied in an example of a Validation Study. Uniform statements may be used across industries, excepting, e.g., minor terminology changes to ensure meaning to respondents.

During the aforementioned interviews, in order to ensure the efficacy of the responses the Data Collection, further described herein (see “Data Collection” section below) may be followed.

Once the survey data is collected according to the Data Collection procedure, the survey data may be stored in the data storage device 270. The microprocessor 210 may operate to perform statistical techniques on the survey data stored in the data storage device 270 to select the final set of Connection statements (for all four levels of Connection) and Loyalty statements most predictive of brand performance across all industries.

For example, the Connection statements may be selected through the following procedure, which may be implemented by the microprocessor 210 executing instructions, e.g., the instructions of the server application stored in the data storage device 270 or other instruction stored in RAM 250 and/or ROM 260:

Assumption Connection (AC) Statements: By the operation of microprocessor 210, each AC statement may be correlated with multiple variables (collectively, the “Independent Variables”) using separate correlation analyses (7 correlations per AC statement) and the results were a correlation coefficient for each AC statement for each Independent Variable. Correlation coefficients may be calculated, e.g., by the operation of the microprocessor 210, as follows:

Correlation coefficient (r)=[Σ(variations from the mean for variable 1)×Σ(variations from the mean for variable 2)]/[number of observations×standard deviation of both variables]. Where the Independent Variables are:

(1) Loyalty Validation Index, as defined on APPENDIX C;
(2) Pricing Power Index, as defined on APPENDIX C;
(3) Relative Price/Earnings Index as defined on APPENDIX C;
(4) Relative Growth Rate Index as defined on APPENDIX C;
(5) Relative Gross Margin Index as defined on APPENDIX C;
(6) Relative Operating Margin Index as defined on APPENDIX C; and
(7) Relative Return on Assets Index as defined on APPENDIX C.

AC Statements with the highest correlation coefficients against the Loyalty Validation Index and Pricing Power Index may be selected. The correlation coefficients of the Relative Price/Earnings, Relative Growth Rate, Relative Gross Margin, Relative Operating Margin, and Relative Return on Assets indices may also be considered, and used to break one or more “ties.” An example of resulting AC statements is set forth in APPENDIX D hereto (and marked with a number including “A”).

A generalization of the statistical technique may be as follows: To validate the effectiveness of a candidate survey question in measuring at least one attribute associated with a plurality of studied subjects, first, from each of n number of responders (n being an integer) a plurality of sets of responses to a set of survey questions are collected. The responses may, for example, be collected online from the survey participants 102 through communication fabric 104. The set of survey questions include the candidate survey question from which the final questions are selected, each of the set of survey questions soliciting a numerical value response, each set of the plurality of sets of responses respectively corresponding to responses to the set of survey questions with respect to one of the plurality of studied subjects.

Then, n arithmetic average values of all responses to each of the set of survey questions with respect to each of the plurality of studied subjects are calculated, from an i^{th} one of said n responders where i is an integer ranging from 1 to n. Then, a correlation coefficient (r) for the candidate survey question is calculated using the formula below:

$$r = \frac{\sum XY - \frac{\sum X \sum Y}{N}}{\sqrt{( \sum {X}^{2} - \frac{{( \sum X )}^{2}}{N} ) ( \sum {Y}^{2} - \frac{{( \sum Y )}^{2}}{N} )}} ,$$

where X represents n responses to the candidate survey question, and Y is the n arithmetic average values. The correlation coefficient is used to determine whether the candidate question is to be selected as the final survey question. Each of the calculations for the arithmetic average values and the correlation coefficient may be performed by the microprocessor 210.

Expectations Connection Statements: Each XC statement may be correlated with the Independent Variables using seven separate correlation analyses, and the results are a correlation coefficient for each XC statement for each Independent Variable. XC Statements with the highest correlation coefficients against the Loyalty Validation Index and Pricing Power Index may be selected. The correlation coefficients of the Relative Price/Earnings, Relative Growth Rate, Relative Gross Margin, Relative Operating Margin, and Relative Return on Assets indices may also be considered, and used to break one or more “ties.” An example of resulting XC statements is set forth on APPENDIX D hereto (and marked with a number including “Ex”).

Enhancement Connection Statements. Each EC statement may also be correlated with the Independent Variables using seven separate correlation analyses, and the results are a correlation coefficient for each EC statement for each Independent Variable. EC Statements with the highest correlation coefficients against the Loyalty Validation Index and Pricing Power Index may be set aside. The correlation coefficients of the Relative Price/Earnings, Relative Growth Rate, Relative Gross Margin, Relative Operating Margin, and Relative Return on Assets indices may also be considered. Next, those EC statements set aside based on correlation coefficients may be analyzed using Factor Analysis, which groups statements into “factor groups” based on the degree of similarity, or commonality, among answers to statements, e.g. certain statements are answered similarly together, forming factor groups. For example, five factor groups may result for the EC statements set aside based on correlation coefficients, and the statements with the highest correlation coefficients within said factor groups may be selected. The permanent EC statements so selected for this example are set forth in APPENDIX D hereto (and marked with a number including “En”).

Transformation Connection Statements. Each TC statement may be correlated against the Independent Variables using seven separate correlation analyses, and the results are a correlation coefficient for each TC statement for each Independent Variable. TC Statements with the highest correlation coefficients against the Loyalty Validation Index and Pricing Power Index may be set aside. The correlation coefficients of the Relative Price/Earnings, Relative Growth Rate, Relative Gross Margin, Relative Operating Margin, and Relative Return on Assets indices may also be considered. Next, those TC statements set aside based on correlation coefficients may be analyzed using Factor Analysis. For example, four factor groups may result for the TC statements set aside based on correlation coefficients, and the statements with the highest correlation coefficients within said factor groups may be selected. The permanent TC statements so selected for this example are set forth on APPENDIX D hereto (and marked with a number including “T”).

Loyalty Statements. Each Loyalty statement may be correlated against the Independent Variables using seven separate correlation analyses, and the results are a correlation coefficient for each Loyalty statement for each Independent Variable. Loyalty statements with the highest correlation coefficients against the Loyalty Validation Index and Pricing Power Index may be selected. The correlation coefficients of the Relative Price/Earnings, Relative Growth Rate, Relative Gross Margin, Relative Operating Margin, and Relative Return on Assets indices were also considered, and used to break one or more “ties.” An example of resulting Loyalty statements is set forth on APPENDIX D hereto (and marked with a number including “L”).

Final Statements. The Final Statements include the Connection and Loyalty statements selected per the forgoing procedure (such statements for this example are set forth in APPENDIX D), the Experience statements (set forth in APPENDIX D), and the Pricing Power measure (set forth in APPENDIX D). APPENDIX D references three groups of Connection statements—CB1, CB2, and CB3. These groupings include Connection statements (AC, XC, EC, TC) randomized in substantially similar proportions across groupings in the survey. The above described selection procedures for the Final Statements may be implemented in the brand benchmarking server 101, e.g., by the microprocessor 210 executing computer instructions. The selected Final Statements may be stored in the data storage device 270 for use in future surveys.

### Data Collection

To ensure the efficacy of the survey results, the following procedures may be followed during data collection:

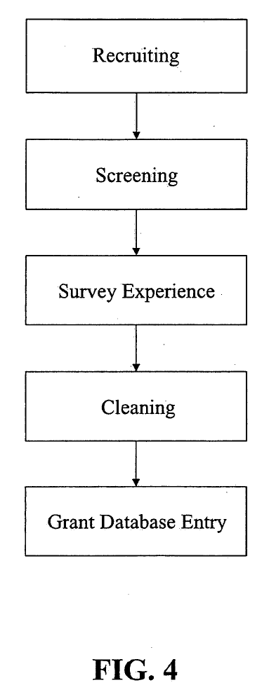

Sample Size. A sufficiently large sample, i.e., the number of the respondents, must be used to ensure accuracy of analysis based on the collected data. For example, for each industry, online interviews of 12,000-15,000 persons may be conducted, which provides the survey results to have a standard margin of error of less than three percentage points (3%). As shown in FIG. 4, the following method may be employed.

Recruiting. Recruiting unbiased survey participants may enhance the integrity of the survey results. Respondents may be predominately recruited through real-time intercept at unrelated websites techniques to ensure absence of bias.

Screening. According to the Data Collection procedure, to be interviewed, respondents may complete a rigorous screener which may use triangulating questions to categorize each person as a current customer of the brand. Triangulating questions may confirm that a respondent is a “decision-maker” for the type of product or service sold by the brand; a regular (and as appropriate, recent) customer of the category; aware of the brand; and a current customer of the brand. A sample set of Screeners is attached hereto as “APPENDIX E”.

Survey Experience. To reduce respondent abuse, the following procedures may be followed to limit the participation of abusive respondents:

1) Unique IDs: A unique numeric ID may be created for each respondent who begins any survey, irrespective of whether the survey is completed.

2) Permanent Removal. Respondents exhibiting “inappropriate behavior” (straight-lining, expeditious completion, as examples) may be restricted from all surveys.

3) Temporary Restriction. Other respondents, for reasons other than inappropriate behavior (quotas full, conflict of interest, as examples), may be prevented from beginning another survey for a limited duration, for example, one quarter.

Cleaning Results. Survey results may undergo cleaning procedures described below. These procedures may be performed by the microprocessor 210 executing machine-executable instructions, and may be completed before any survey results are permitted to be loaded into database in the data storage device 270.

1) Completed Survey Check. Survey statements and questions may be examined to determine if they are complete, including all Screener questions. Incomplete results may be omitted.

2) Correct Survey Reconciliation. Statements and questions presented to each respondent may be reconciled with a master list of Screener questions and Final Statements. If such reconciliation fails (such as 100% correct), the results may be omitted.

3) Under 18. Respondents who are under age, who attempt to complete the survey, may be removed from the sample.

4) 90% Check. Respondents completing 90% or more of Connection and Loyalty statements with the same answer choice may be removed from the sample. This check removes “straight-liners”, and persons who may be evading other straight-line checks by randomly answering some statements correctly.

5) 90% Check on Back Third. Respondents completing 90% or more of the Connection statements with the same answer choice the back third (in the present example, the final 30 Connection statements of the Final Statements) of the survey may be removed from the sample. This check may remove persons who begin the survey with good intentions, but become tired or distracted intra-survey.

6) Conflict Check. Respondents may be asked questions about their professions and affiliations, as well as the professions and affiliations of others in their households. Respondents working in or around the brand being studied, or category in which the brand operates, may be removed from the sample. An example of conflict check questions are described on APPENDIX E.

7) Decision Maker Question: Respondents may be asked to confirm their affirmative role in making the decision to buy relevant products and services, as set forth on APPENDIX E. Respondents failing to answer this question affirmatively may be omitted.

8) Category Customer Question: Respondents may be asked to confirm their purchase of goods and services from companies (any) in the industry in which the brand being studied operates, as exemplified in APPENDIX E. Respondents failing to answer these questions affirmatively may be omitted.

9) Awareness Questions. Respondents may be asked to confirm their awareness of one or more brands being studied, as exemplified in APPENDIX E. Respondents failing to answer these questions (at least one awareness question) affirmatively may be omitted.

10) Customer Questions: Respondents may be asked to confirm their role as customers of one or more brands being studied, as exemplified in APPENDIX E. Respondents failing to answer said question (at least one customer-of question) affirmatively may be omitted.

11) Awareness-Customer Logic: Respondents may only be asked questions for those brands of which they state they are aware. Such logic may be confirmed. Any respondents stating they are a customer of a brand of which they are not aware may be omitted.

12) Time Check. Respondents completing the entire Survey in less than a minimum amount of time may be removed from the sample. For example, such minimum of 35% of average survey length as determined during the first 96 hours of a survey being launched may be used.

13) Time Check on Back Third. Respondents completing the back third of the survey in less than a minimum amount of time may be removed from the sample, eliminating persons who proceed methodically and then accelerate their responses (though still randomizing their answers) just to finish. Such minimum may be 20% of the average time, as set forth above.

14) Red Herrings. The survey may include multiple red herring questions (repeating the same questions twice, randomly in different locations in the survey). Respondents failing to answer these questions identically may be removed from the sample. Examples of red herring questions are described on APPENDIX E.

15) Screener Reconciliations. Screener logic may be reconfirmed during the cleaning procedures. Respondents' requirements, as measured through numerous triangulating screening questions, to be (1) relevant decision makers, (2) category customers, (3) aware of the brand, and/or (4) a customer of the brand, may be validated.

16) Quota Reconciliations. Quota logic may be reconfirmed during the cleaning procedure. Each brand's respondents, in aggregate, may be compared to US Census statistics, with permitted differences as exemplified in APPENDIX F, to validate quota compliance.

17) Required Sample Size. The required number of interviews, per brand, may be confirmed.

18) Special Requirements. For some brands, additional screening requirements may be necessary, e.g. women only for cosmetics, or income requirement for luxury automobiles. Compliance with such additional requirements may be validated before data is permitted entry into the database.

Census Representative. In addition, quotas may be used to ensure results are representative of the 2000 US Census insofar as age, gender, and ethnicity. For example, only a small deviation, e.g., plus/minus three percentage points, from the relative age and gender US Census statistics may be permitted. Ethnicity may vary by as much as five percentage points. APPENDIX F sets forth an example of percentages for age, gender and ethnicity for quota compliance, in aggregate, on a brand-by-brand basis.

### Analytics

According to an embodiment, the Brand Relationship Model may consider five dimensions (“Brand Dimensions”) of a customer's relationship with a brand in order to provide visual, quantitative, and actionable metrics and benchmarks. As described earlier, such dimensions are:

1) Connection: (see APPENDIX D, all statements labeled with an “A”, “Ex”, “En”, or “T”);

2) Experience: (see APPENDIX D, all statements labeled with an “X”);

3) Loyalty: (see APPENDIX D, all statements labeled with an “L”);

4) Pricing Power: Attribute relating to customers' perception of pricing power (see APPENDIX D); and

5) Connection Attribute Scores. Each of the unique attributes of Connection are scored 1-10 by respondents in the survey. The score for each such attribute may be calculated by arithmetically averaging the scores each respondent provides for each attribute.

Five Connection Scores for each brand studied may be calculated in the brand benchmarking server 101, e.g., by the microprocessor 210 executing computer instructions, and thereby manipulating data stored in the data storage device 270, as follows:

1) Assumption Connection Score: Each Assumption Connection attribute (see examples of the Assumption Connection statements in APPENDIX D) may be assigned a unique weight, and the Assumption Connection Score for a particular brand, or segment of customers for a brand, may be calculated by weight-averaging the score of each Assumption Connection attribute. The weights may be derived from the Validation Study, and the weight for each Assumption Connection statement may represent the degree of predictiveness of such statement. APPENDIX G sets forth examples of the weights for the Assumption Connection statements. Such weights may reflect the proportionate contribution of each Assumption Connection statement, based on each such statement's correlation coefficient to the Loyalty Validation Index.

2) Expectation Connection Score: Each Expectation Connection attribute (see examples of the Expectation Connection statements in APPENDIX D) may be assigned a unique weight, and the Expectation Connection Score for a particular brand, or segment of customers for a brand, may be calculated by weight-averaging the score of each Expectation Connection attribute. The weights may be derived from the Validation Study, and the weight for each Expectation Connection statement may represent the degree of predictiveness of such statement. APPENDIX G sets forth examples of the weights for the Expectation Connection statements. Such weights may reflect the proportionate contribution of each Expectation Connection statement, based on each such statement's correlation coefficient to the Loyalty Validation Index.

3) Enhancement Connection Score: Each Enhancement Connection attribute (see examples of the Enhancement Connection statements in APPENDIX D) may be assigned a unique weight, and the Enhancement Connection Score for a particular brand, or segment of customers for a brand, may be calculated by weight-averaging the score of each Enhancement Connection attribute. The weights may be derived from the Validation Study, and the weight for each Enhancement Connection statement may represent the degree of predictiveness of such statement. APPENDIX G sets forth examples of the weights for the Enhancement Connection statements. Such weights may reflect the proportionate contribution of each Enhancement Connection statement, based on each such statement's correlation coefficient to the Loyalty Validation Index.

4) Transformation Connection Score: Each Transformation Connection attribute (see examples of the Transformation Connection statements in APPENDIX D) may assigned a unique weight, and the Transformation Connection Score for a particular brand, or segment of customers for a brand, may be calculated by weight-averaging the score of each Transformation Connection attribute. The weights may be derived from the Validation Study, and the weight for each Transformation Connection statement may represent the degree of predictiveness of such statement. APPENDIX G sets forth examples of the weights for the Transformation Connection statements. Such weights may reflect the proportionate contribution of each Transformation Connection statement, based on each such statement's correlation coefficient to the Loyalty Validation Index.

5) Total Connection Score: The Total Connection Score for each brand may be calculated using the following formula:

Total Connection Score=Σ(Assumption Connection Score, if ≧6);

(Expectation Connection Score if ≧6 and Assumption Connection Score ≧6);

(Enhancement Connection Score if ≧7 and Expectation Connection Score ≧6 and Assumption Connection Score ≧6);

(Transformation Connection Score if ≧7 and Enhancement Connection Score ≧7, Expectation Connection Score ≧6 and Assumption Connection Score ≧6).

Experience Analytics. Experience analytics may be designed to identify those customer experiences, or touch-points, which drive either positively or negatively Connection and Loyalty. Two actionable metrics may result from the analytics, which are:

1) Experience Scores: Experience Score for each level of Connection (specifically the Assumption Experience Score, Expectation Experience Score, Enhancement Experience Score, and Transformation Experience Score) and for overall Connection (Total Connection Experience Score). The five Experience Scores may be calculated in the benchmarking server 101, e.g., by the microprocessor 210 executing computer instructions, and thereby manipulating data stored in the data storage device 270, as further described below.

2) Experience Priority List: A ordered rank list of customer experiences based on each experience's contribution to Connection. A rank-order list may be generated for each level of Connection, and for overall Connection.

Experiences Measured: As described earlier, during the survey, information may be gathered from respondents about unique experiences with respect to a brand, for example, the 45 statements listed in APPENDIX D. Information collected from respondents for this attribute may be limited to binary “Yes/No” answers, indicating whether each respondent did or did not have a certain experience within a relatively recent timeframe. Respondents need not be asked to score consciously the “quality” of each experience.

Dimensions of Experience Analytics: Experience Analytics may consider three dimensions of each Customer's overall “Experience,” which are:

1) Diversity. Based on empirical data, statistically, customers who partake in a wider range of experiences exhibit higher Connection and Loyalty scores;

2) Contribution. Certain experiences contribute positively to Connection, and such contributions may be quantified; and

3) Detraction. Certain experiences contribute negatively to, or detract from, Connection, and such detraction may be quantified.

Formulae to calculate experience: With valid data concerning customers' actual Experiences with and Connection to a brand, the microprocessor 210 may execute instructions to apply statistical formulae to the valid data that may be stored in the data storage device 270 to determine (1) an Experience Score for each level of Connection per brand (5 such Experience Scores), and (2) a relative contribution or detraction score for each individual experience.

Such formulae may utilize a general analytical method, e.g., stepwise regression (forward selection of items), one at a time, using multivariable linear regression (regressing each experience against each level of Connection, with Connection Scores used), followed by backward elimination (also using Connection Scores), also one item at a time. Forward selection and backward elimination are defined below.

Forward selection may start with an empty model. The variable (in this case, an Experience) that has the smallest P value when it is the only predictor in the regression equation may be placed in the model. Each subsequent step adds the variable (an Experience) that has the smallest P value in the presence of the predictors (other Experiences) already in the equation. Variables may be added one-at-a-time as long as their P values are small enough, typically less than 0.05 or 0.10.

Backward elimination may start with all of the predictors (all Experiences) in the model. The variable that is least significant—that is, the one with the largest P value—may be removed and the model may be refitted. Each subsequent step may remove the least significant variable in the model until all remaining variables have individual P values smaller than some value, such as 0.05 or 0.10.

During each phase of item selection, a single experience item may be selected (forward selection), e.g., the experience item that when added to the linear regression model (regressing experiences and each level of Connection) results in the largest, statistically significant reduction of the computed Akaike's information criteria (AIC). AIC is a well-known statistical technique for determining what occurrences most contribute to an outcome. This forward selection process may stop when addition of any single item does not result in a statistically significant reduction of AIC; when AIC stops declining, the multivariable regressions may stop.

This process may then be followed by a procedure of backward experience item elimination. During each phase of experience item elimination (using multivariable linear regression, with each experience regressed against Connection Scores (5)), items may be removed from the model, one at a time, and the resultant increase in AIC is calculated and tested for statistical significance. Items may be removed if the resultant increase of AIC is not statistically significant.

The statistical significance of experience addition or removal (for forward selection, or backward elimination) may be assessed using a F-test and significance level of 0.05. Simply, combining forward selection and backward elimination procedures, using multivariable linear regressions, simultaneously, enables selection of experiences that most contribute to Connection.

Each experience may be assigned a weight, or individual score, reflecting its contribution to, or detraction from, each level of Connection; meaning each experience is assigned 5 different scores. Such scores may be byproducts of the multivariable regressions. Experiences included in the model, following the forgoing forward selection and backward elimination, may be isolated, and the scores thereof (5 scores per experience included, based on statistical significance) may be summed for each level Connection, resulting in five Experience Scores.

Loyalty Scores for Each Brand. A Loyalty Score for each brand may be calculated in the brand benchmarking server 101, e.g., by the microprocessor 210 executing computer instructions, and thereby manipulating data stored in the data storage device 270. Each of the Loyalty attributes (e.g., the 12 Loyalty statements in APPENDIX D), for a particular brand, may be scored by arithmetically averaging respondents' answers. Each Loyalty attribute may be assigned a unique weight, and the Loyalty Score for a particular brand, or segment of customers for a brand, may be calculated by weight-averaging the score of each Loyalty attribute. The weights may be derived from the Validation Study, and the weight for each Loyalty statement represents the degree of predictiveness of such statement. APPENDIX G sets forth examples of the weights for the Loyalty statements. Such weights may reflect the proportionate contribution of each Loyalty statement, based on each such statement's correlation coefficient to the overall Loyalty Validation Index.

Pricing Power for Each Brand. A Pricing Power Score for each brand may be calculated in the brand benchmarking server 101, e.g., by the microprocessor 210 executing computer instructions, and thereby manipulating data stored in the data storage device 270, and by arithmetically averaging each respondent's perceived Pricing Power. (As described earlier, the survey may include a visual scale whereby respondents determine if a brand's prices should be, above, or below industry average; see APPENDIX D.)

Total Brand Score A single overall score of brand performance encompassing Connection, Experience, Loyalty and Pricing Power (“Brand Score”) may be calculated in the brand benchmarking server 101, e.g., by the microprocessor 210 executing computer instructions, and thereby manipulating data stored in the data storage device 270. This score may be based on the formula for the volume of a tetrahedron, i.e., V=⅓*B*H, where B=area of the base of the tetrahedron and H=height of the tetrahedron. B is calculated using the formula for the area of a triangle: A=½*b*h, where b=length of the base and h=height of the base.

Accordingly, the Brand Score=[⅓*(½*Experience Input*Loyalty/Pricing Power Composite)*Total Connection], where:
1) Experience Input=ΣExperience Left Input and Experience Right Input,
   where the Experience Left Input=Expectation Experience Score if Experience Connection >=6 and Assumption Connection >=6, or the Assumption Connection Score if Assumption Connection >=6 but Expectation Connection <6, or 0 if Assumption Connection <6,
   and where the Experience Right Input=Transformation Experience Score if Transformation Connection >=7, Enhancement Connection >=7, Expectation Connection >=6, and Assumption Connection >=6, or the Enhancement Experience Score if Transformation Connection <7, but Enhancement Connection >=7, Expectation Connection >=6 and Assumption Connection >=6, or 0 if Enhancement Connection <7.
2) Loyalty/Pricing Power Composite=Loyalty Score*(1+Pricing Power, expressed as a percentage)
3) Total Connection=score per the formula for Total Connection.

Benchmarks. Based on the measurements of a number of brands, e.g., 30-50 brands, in each industry, which are preferably selected to provide brands representing diverse companies (insofar as size, corporate health, competitive strategy focus, and geography), industry benchmark may be calculated in the brand benchmarking server 101, e.g., by the microprocessor 210 executing computer instructions, and thereby manipulating data stored in the data storage device 270.

1) Connection Benchmarks: Five Connection Benchmarks may be produced, including: Assumption, Expectation, Enhancement, Transformation and Total Connection. Each Connection Benchmark may be calculated by weight-averaging the Connection Scores for each brand measured in the industry, with market share (based on customer usage) used as the weight. The calculation of market share will be described later.

2) Experience Benchmarks: Two types of Experience Benchmarks may be produced, including: Experience Score Benchmarks, and Experience Drivers, across the industry. Five Experience Score Benchmarks may be calculated—one for each level of Connection—by weight-averaging the Experience Scores (as described above) for each brand measured in the industry, with market share used as the weight. (Market share weights are discussed below.)

Experience Drivers may be rank-ordered—across the industry, for each level of Connection—by applying Experience formulae (forward processing, backward elimination) to all respondents in the industry, vs. only the respondents for one brand as described above, i.e. Five Connection Benchmarks are calculated for the entire industry (as described above) and used in forward selection and backward elimination multivariable linear regression procedures to determine which experiences contribute to, detract from, and are statistically irrelevant to, each level of Connection, across all brands in the entire industry.

Loyalty Benchmark. A Loyalty Benchmark may also be produced. To that end, the Loyalty Scores for each brand may be weight-averaged, with market share weight is used as the weight.

Pricing Power Benchmark. A Pricing Power Benchmark may also be produced. To that end, the Pricing Power Scores for each brand may be weight-averaged, with market share weight is used as the weight.

Total Brand Benchmark: A Total Brand Benchmark may be produced by weight-averaging the Total Brand Scores for each brand with the market share weight used as the weight.

Market Share Weights: Market Share weights may be calculated through the following process: Annually, for each industry, a separate study (“Market Share Study”) may be conducted. The Market Share Study may be conducted with no fewer than 1,000 persons per sub-industry of each such industry (e.g. banking a sub-industry of financial services). Each respondent may be asked a series of questions about the brands in such industry, such as, for example, similar to questions 1-5a of the Screener, attached hereto as APPENDIX D. Such interviews provide information regarding the incidence of usage of a category (e.g. % of a population using banking products) and the incidence of usage of each brand therewithin. If one sub-industry only exists for a particular industry, the following formula may be used to determine the market share weight for each brand: # of people who affirm usage of each brand/# of people interviewed. If more than one sub-industry exists for a particular industry, the following method may be used to determine the market share weight for each brand: First, # of people using each sub-industry/# of people interviewed provides an incidence weight for each sub-industry (“Sub-Industry Weight”). Second, the # of people who affirm usage of each brand/# of people interviewed provides an incidence weight for each brand (“Brand Weight”).

The formula may then be applied: Σ(Sub-Industry Weight (1)*Brand Weight (1×)) . . . (Sub-Industry Weight (2)*Brand Weight (2×)).

All of the calculations described herein may be performed automatically by a database systems in the brand benchmarking server 101. APPENDIX H provides a detailed description of an embodiment of the database.

### Visual Model

A tetrahedron is a three-sided pyramid, which may be used as a model (the “Brand Relationship Model” or “Model”) to illustrate the strength of a brand.

Human Relationship Model. The premise underlying the Model is a human-human relationship (“HRM”). When two humans first meet, factors such as trust and safety guide the level of Connection between such persons. As the two have more experiences together, the level of Connection grows: the two become satisfied with each other and confident the other is a reliable friend or qualified colleague. Over time, as the pair continue to undertake experiences, the Connection grows, to a point where the individuals will advocate or defend each other, and ultimately to a point where the individuals feel their lives are improved by the other. As Connection grows, so does Loyalty and Commitment.

HRM Applied to Brand. The relationship between two individuals on the one hand, and an individual and brand on the other hand, mirror each other. Humans build Connection with a brand over time, through experiences with such brand (e.g. using the product, interacting with customer service, seeing ads). As Connection grows (per the Connection hierarchy—Assumption, then Expectation, then Enhancement, then Transformation), the customer becomes more loyal and willing to pay price premiums.

Dimensions of the Model. A three-sided, three-dimensional tetrahedron has three axes: a Y-axis extending vertically, an X-axis extending horizontally, and a Z-axis, providing three dimensionality and extending forward.

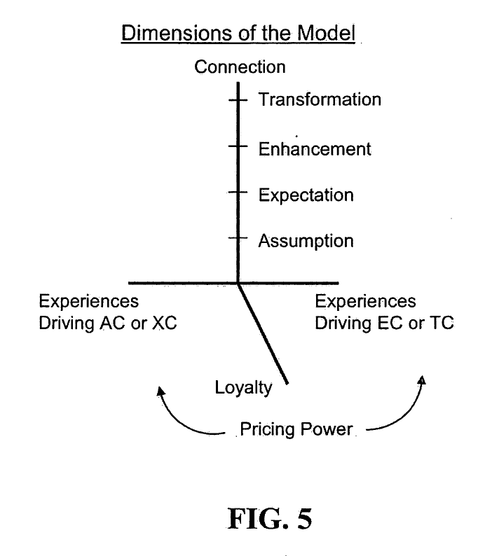

Referring to FIG. 5, the Y-Axis illustrates Connection. A brand's Connection with its customers or prospective customers may be illustrated by the height of the tetrahedron along the Y-Axis. Such height may be the Total Connection Score (a number between 0-40), as previously defined.

The X-Axis illustrates Experiences Driving Connection: Unless stated otherwise, the tetrahedron may intersect the X-Axis in two locations, one to the left of the intersection of the axes (“X-Left Intercept”), and one to the right of the intersection of the axes (“X-Right Intercept”). The X-Left Intercept may be the Expectation Experience Score (a number between 1-10), except if the Expectation Connection Score <6, in which case the X-Left Intercept may be the Assumption Experience Score (a number between 1-10), except if the Assumption Connection Score <6, in which case the Model need not be drawn at all, and only the blank axes may be drawn. The X-Right Intercept may be the Transformation Experience Score (a number between 1-10), except if the Transformation Connection Score <7, in which case the X-Right Intercept may be the Enhancement Experience Score (a number between 1-10), except if the Enhancement Connection Score <7, in which case the X-Right Intercept may be that second point on the X-Axis, in addition to the X-Left Intercept, at which the tetrahedron intercepts the X-Axis in order to intercept the Z-Axis, unless if Assumption Connection Score <6, in which case the Model need not be drawn at all, and only the blank axes may be drawn.

Z-Axis illustrates the Loyalty and Pricing Power. The Loyalty Score (a number between 1-10), as previously defined, may determine the intersection of the tetrahedron and the Z-Axis. The Loyalty Score may determine the depth of the tetrahedron. The Pricing Power Score (a number between −50-50), as previously defined, may determine the angle of the Z-Axis.

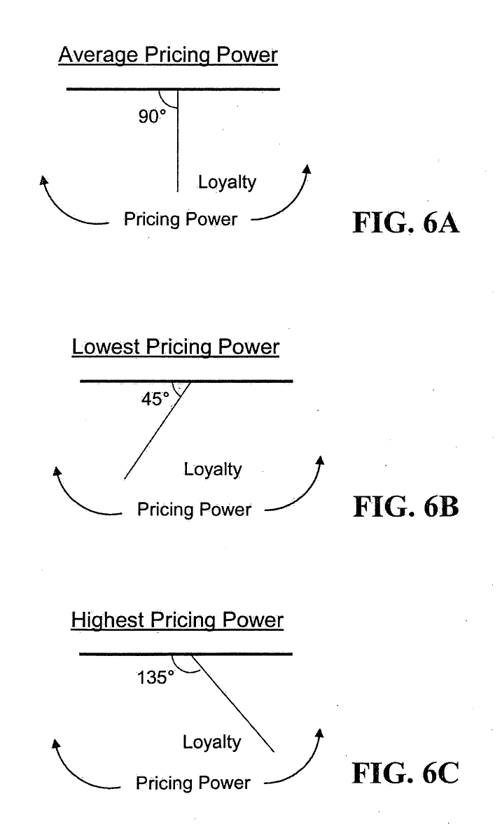

As shown in FIG. 6A through 6C, the Pricing Power Score range may be proportionate to a range of geometric angles at the intersection of the X-Axis and Z-Axis, from 45 degrees to 135 degrees. As described earlier, a survey respondent answers the Pricing Power question (as set forth on APPENDIX A) by selecting “Average Price” or moving a scale +/−50 points from Average Price. Average Price is depicted by a Z-Axis which forms a 90 degree angle with the X-Axis as shown in FIG. 6A. Lowest Pricing Power (−50) is depicted by a Z-Axis which forms a 45 degree angle with the X-Axis as shown in FIG. 6B. Highest Pricing Power (+50) is depicted by a Z-Axis which forms a 135 degree angle with the X-Axis as shown in FIG. 6C.

The angle may be determined as follows: (1) If the Pricing Power is equal to 0 (Average Price), the angle is 90 degrees; (2) If the Pricing Power Score is >0, the angle is determined by (a) dividing the Pricing Power Score by 45 degrees, providing a quotient and then (b) multiplying said quotient by 45 degrees providing a product, and then (c) adding the product to 90 degrees; and (3) if the Pricing Power Score is <0, the angle is determined by (a) dividing the Pricing Power Score by 45 degrees, providing a quotient (negative number) and then (b) multiplying said quotient by 45 degrees providing a product (negative number), and then (c) adding said product to 90 degrees.

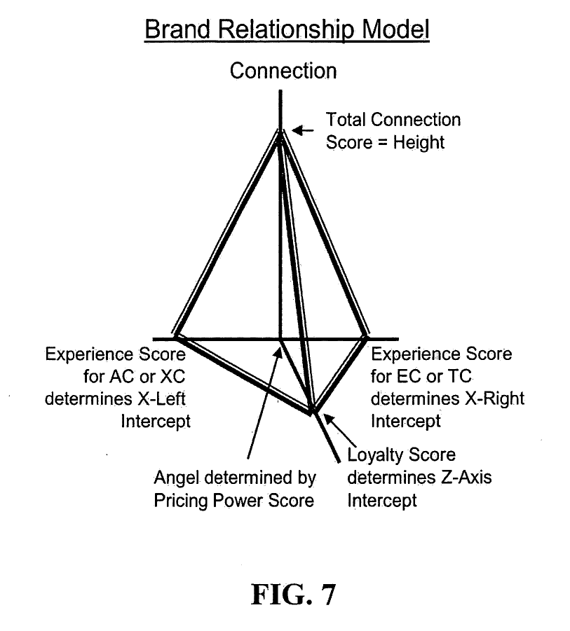

Completed Model. The Brand Relationship Model shown in FIG. 7 depicts customers' relationship with a brand. The Total Connection Score may determine the Y-Axis intercept. As described above, either the Expectation Experience Score (also called the Experience Score for XC) or the Assumption Experience Score may determine the X-Left Intercept. As described above, either the Enhancement Experience Score or the Transformation Experience Score may determine the X-Right Intercept. The Loyalty Score may determine the Z-Axis intercept, and the Pricing Power Score may determine the angle of the Z-Axis intercept with the X-Axis. With four points plotted (Y-Axis, two on X-Axis, and Z-Axis) and the angle of the Z-Axis determined, lines are drawn connecting the points, and the Brand Relationship Model is completed.

The Brand Relationship Model may be constructed in the brand benchmarking server 101, e.g., by the microprocessor 210 executing computer instructions, and thereby manipulating data stored in the data storage device 270, and may be displayed on the display 240 or in the alternative at the display screen(s) of one or more of the brand information users 103. The brand information users 103 may communicate with the brand benchmarking server 101 through the communication fabric 104 to access one or more server application programs stored in the data storage device 270 to have on the display screen of the brand information user the Brand Relationship Model of one or more brand(s). For example, the microprocessor 210 may implement web-server application to allow the brand information users 103 to access the various server applications from the brand benchmarking server 101 by the use of web browsers or the like. The Brand Relationship Model may be used to model the segments of one brand, using the aforementioned formulae, rules and guidelines as shown in FIG. 7. In addition, the Brand Relationship Model may be used to model all brands in an industry, per the following rules:

1) Connection: While the Total Connection Score may be used to determine the Y-Axis intercept when modeling one brand, the Total Connection Benchmark may be used in substitution when modeling all brands in an industry.

2) Experience: While the Assumptions Experience Score, or Expectations Experience Score, or neither as the case may be, may be used to determine the X-Left Intercept when modeling one brand, the Assumptions Experience Benchmark, or Expectations Experience Benchmark, or neither as the case may be, may be used to determine the X-Left Intercept when modeling all brands in an industry, and all rules applicable to the X-Left Intercept for one brand may be applied when modeling all brands in the industry. While Enhancement Experience Score, or Transformation Experience Score, or neither as the case may be, may be used to determine the X-Right Intercept when modeling one brand, the Enhancement Experience Benchmark, or Transformation Experience Benchmark, or neither as the case may be, may be used to determine the X-Right Intercept when modeling all brands in an industry, and all rules applicable to the X-Right Intercept for one brand may be applied when modeling all brands in the industry.

3) Loyalty: While the Loyalty Score may be used when modeling one brand, the Loyalty Benchmark may be used when modeling all brands in an industry.

4) Pricing Power: While the Pricing Power Score may be used when modeling one brand, the Pricing Power Benchmark may be used when modeling all brands in an industry, and all rules applicable to the Pricing Power Score may be applied to the Pricing Power Benchmark.

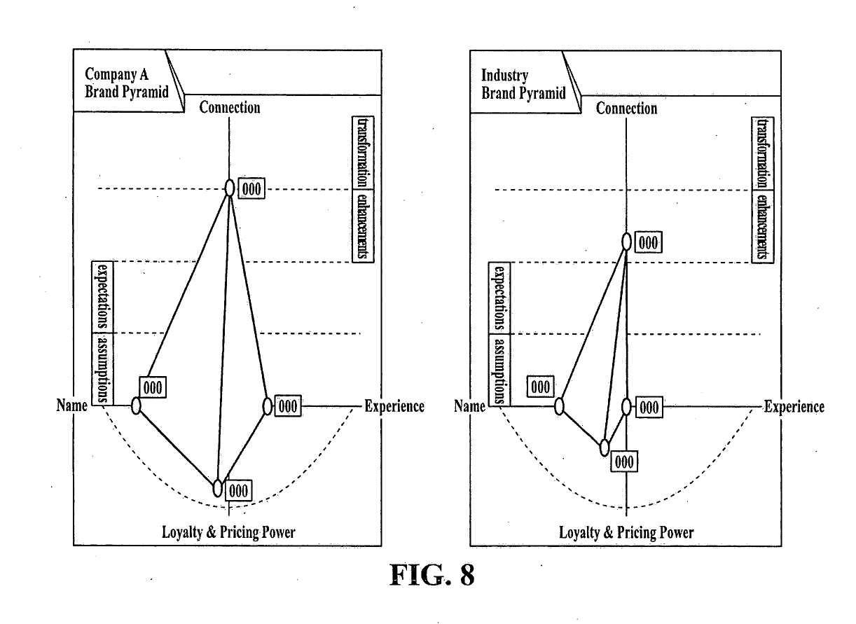

As shown in FIG. 8, Brand Relationship Model of a brand may be shown side-by-side with the Brand Relationship Model for all brands in the industry to provide a visual representation of the strength of the brand in relation to the industry.

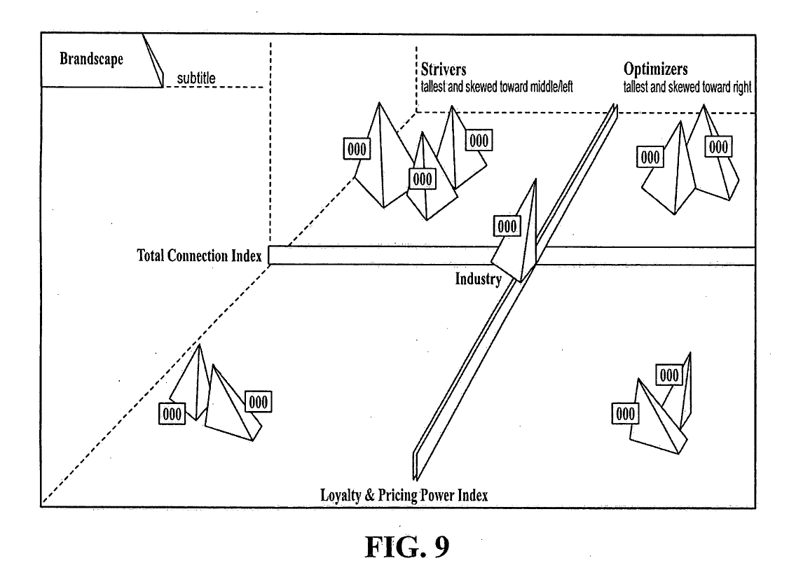

Relative Modeling of Industry Brands. The Brand Relationship Models for multiple brands in an industry may be compared on a three-dimensional, four quadrant display (print and computer interface), the X-Axis of such display representing Pricing Power Adjusted Loyalty for each brand (as defined below) and Y-Axis of such display representing Total Connection for each brand. The three digit numbers next to each brand represent each brand's Brand Score. “Pricing Power Adjusted Loyalty” may be calculated by multiplying each brand's Loyalty Score times the sum of 1 and its (the brand's) Percentage Pricing Power Score (as defined below). Each brand's “Percentage Pricing Power Score” is defined as such brand's pricing power (a number between −50-50) divided by 100. An example of the relative modeling of industry brands is shown in FIG. 9.

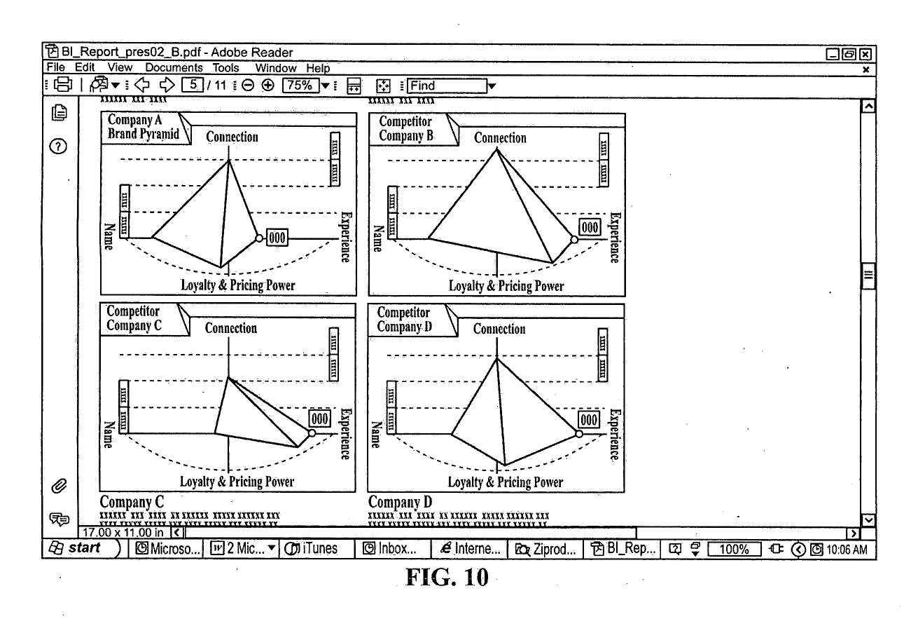

Comparative Modeling of Brands. As shown in FIG. 10, the Brand Relationship Models for specific competitors may be compared side by side. Models are created for each such competitor using the forgoing rules and procedures, and the models are then displayed on screen simultaneously.

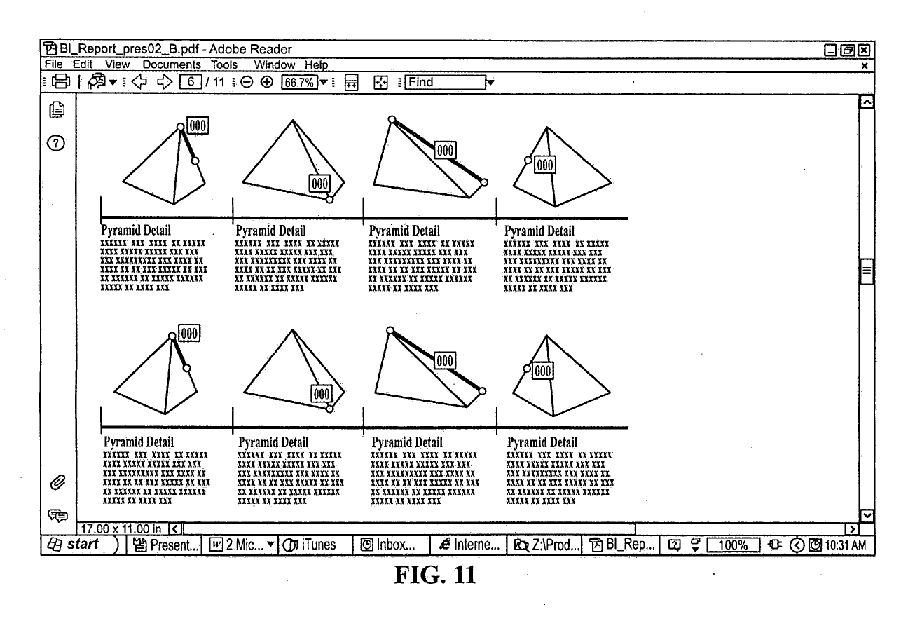

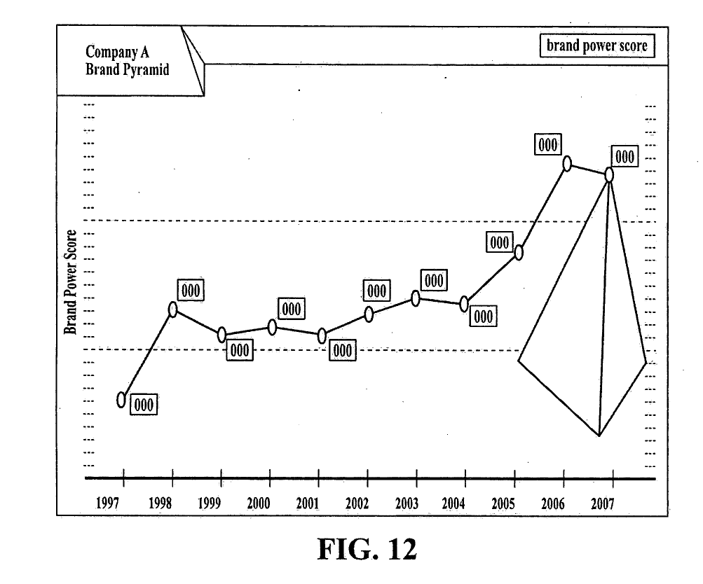

Time Series Comparisons. The Brand Relationship Model may be used to illustrate changes, over time, in brand performance. FIG. 11 shows one example of such illustrations. As shown in FIG. 11, eight pyramids are shown sequentially (from top left to bottom right) on screen, each representing a different point in time. FIG. 12 shows another example of a chart illustrating the change in the Brand Score over time, with the then current Brand Relationship Model illustrated.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

### APPENDIX A

### Original Statements

1. Using a 1 to 10 scale, where 10 is strongly agree and 1 is strongly disagree, to what extent do you agree or disagree with the following statements?
   (ROTATE, INSERT LOYALTY STATEMENTS HERE; LOYALTY STATEMENTS ON FOLLOWING PAGES)
2. Using a 1 to 10 scale, where 10 is strongly agree and 1 is strongly disagree, to what extent do you agree or disagree with the following statements?
   (ROTATE, INSERT CB1 STATEMENTS HERE; CBI STATEMENTS ON FOLLOWING PAGES)
3. The next question relates to the value you associate with (INSERT BRAND NAME's) products/services relative to the products/services of competitors. Using the scale below, please indicate the extent to which you think (INSERT BRAND NAME's) products/services are worth more than the industry average, worth less than the industry average, or are equal to the industry average?
   Less than industry average More than industry average
   −10%−20%−30%−40%−50% Average industry price +10%+20%+30% 40%+50%
4. Using a 1 to 10 scale, where 10 is strongly agree and 1 is strongly disagree, to what extent do you agree or disagree with the following statements?
   (ROTATE, INSERT CB2 STATEMENTS HERE; CB2 STATEMENTS ON FOLLOWING PAGES)
5. The next section of questions relate to your experiences with (INSERT BRAND) over the last year. Please answer each question based on your experiences over the last year.
   (ROTATE, INSERT EXPERIENCE STATEMENTS HERE; EXPERIENCE STATEMENTS ON FOLLOWING PAGES)
   1 Yes
   2 No
6. Using a 1 to 10 scale, where 10 is strongly agree and 1 is strongly disagree, to what extent do you agree or disagree with the following statements?
   (ROTATE, INSERT CB3 STATEMENTS HERE; CB3 STATEMENTS ON FOLLOWING PAGES)

### BRAND INFORMATICS, INC.

### Original Statements

### LOYALTY

L1 Overall, I am loyal to Brand XX.
L2 I would recommend Brand XX to a friend or colleague.
L3 I have recommended Brand X to a friend or colleague.
L4 I use Brand XX most often.
L5 I've tried competitive brands, but have gone back to Brand XX.
L6 Even if a competitor lowered its price or fees, I still would not switch from Brand XX.
L7 I don't feel comfortable switching from Brand XX.
L8 I will not switch from Brand XX.
   When I'm considering my next need, I don't even look at the competition. I go straight to
L9 Brand XX.
L10 I look for Brand XX first.
L11 I will definitely try the next service from Brand XX.
L12 I pay more for Brand XX.
   It would take a significant improvement from another brand to get me to switch from Brand
L13 XX.
L14 I love Brand XX.
L15 I would get upset if Brand XX were not available.
L16 I will be using Brand XX five years from now.
L17 It's just too much trouble to switch from Brand XX.
L18 If Brand XX wasn't available, I would wait for it.
L19 I have gone out of my way to use Brand XX.
L20 Even if Brand XX made a mistake, I would stick with them.
L21 Although Brand XX has disappointed me, I stick with them.

### CB1

T1 I use Brand XX because it makes me feel better.
T2 Brand XX gives me confidence that the future will be better.
T3 Brand XX helps improve life for my family.
T4 Brand XX helps me create a better home life.
T5 Brand XX helps me become the person I want to be.
T6 Brand XX helps me achieve my personal goals.
T7 Brand X helps me succeed in life.
T8 Brand XX lets me be myself.
T9 Brand XX helps me live life the way I want to live it.
T10 Brand XX gives me a feeling of control.
T29 I get a feeling of happiness when I use Brand XX.
T30 Brand XX helps me escape from everyday life.
T31 Brand XX gives me a real thrill.
T32 Brand XX is entertaining.
T41 Using Brand XX tells people I'm successful.
T42 I could see myself in a commercial for Brand XX.
T43 Using Brand XX tells something about who I really am.
T52 I feel I've earned the privilege to use Brand XX.
T53 I feel I belong with other people who use Brand XX.
EN1 Overall, Brand XX stands out from other brands.
EN2 Brand XX has features no one else has.
EN3 Brand XX has the features I want most.
EN9 Brand XX is a leader in its industry.
EN10 Brand XX is a global brand.
EN11 Brand XX is a respected brand.
EN12 I admire Brand XX as a company.
EN13 I expect Brand XX to be a leader in the future.
EN14 Brand XX knows its industry better than anyone.
EN28 Brand XX is authentic and genuine.
EN29 Brand XX has its own style and personality.
EN30 Brand XX is seen as a cool brand.
EN38 Brand XX understands my lifestyle.
EN39 Brand XX understands how people are using their products and services.
EN40 Brand XX understands what kind of person I am.
EN47 Brand XX is for people my age.
EN48 Brand XX is a brand for young people.
EX1 Overall, I am satisfied with Brand XX.
EX2 I've had good experiences with Brand XX.
EX5 Brand XX performs as promised.
EX6 Brand XX is a quality brand.
EX7 Brand XX performs as advertised.
EX15 The people at Brand XX are helpful.
EX17 With Brand XX, I get what I pay for.
A1 Overall, I find Brand XX to be safe and trustworthy.
A3 Brand XX meets industry standards.
A4 I have confidence in Brand XX's products and services.
A9 Brand XX is a trustworthy company.

### CB2

T11 share important values with Brand XX.
T12 Brand XX makes me feel sexier.
T13 Brand XX helps me be closer to the people I love.
T14 Brand XX helps me be more powerful in life.
T15 Brand XX makes me feel younger.
T16 Brand XX brings some order and structure to my life.
T17 By choosing Brand XX, I've know I've made a smart decision.
T18 By choosing Brand XX, I get a feeling of accomplishment.
T19 Brand XX helps me feel secure.
T33 Brand XX helps me feel free and independent.
T34 Brand XX is fun.
T35 Brand XX helps take me to an exotic place.
T36 Brand XX adds excitement into my life.
T44 Brand XX reflects my personality.
T45 Brand XX reflects my personal lifestyle.
T46 People see me differently because I use Brand XX.
T47 People seem to admire that I use Brand XX.
T54 Using Brand XX helps me fit in with friends or colleagues.
T55 By choosing Brand XX I'm also doing something good for society.
EN4 Brand XX has the features that are most important to people.
EN5 Brand XX always seems to get their products and services right.
EN6 Brand XX always comes out with the best new products and services.
EN15 Brand XX has strong leaders in the company.
EN16 Brand XX is always ahead of curve.
EN17 Brand XX sets the pace for its industry.
EN18 Brand XX has shaped our culture.
EN19 Brand XX has influence in its marketplace.
EN20 Brand XX are the experts of their industry.
EN31 Brand XX is in style.
EN32 There is a certain “aura” around Brand XX.
EN33 I find Brand XX to be entertaining.
EN34 I find Brand XX to be attractive.
EN41 Brand XX always takes care of its customers
EN42 Brand XX has my interests at heart.
EN43 People who work at Brand XX are passionate about what they do.
EN49 Brand XX reminds me of how things used to be.
EX3 Brand XX solves problems or issues.
EX8 Brand XX has consistent quality and performance.
EX9 Brand XX is reliable.
EX10 Brand XX products and services are up-to-date.
EX11 Brand XX is stylish.
EX19 People generally consider Brand XX as a good brand.
A2 I will be safe using Brand XX products or services.
A4 I don't have to worry when I use Brand XX.
A7 I believe what Brand XX tells me.
A10 I believe the Brand XX company is honest.

### EXPERIENCE STATEMENTS

X1 I use Brand XX products.
X2 I share my Brand XX experience with others.
X3 I have other products with Brand XX logos on them.
X4 I've dealt with Brand XX's sales people.
X5 I have read or reviewed Brand XX's brochures or other printed information.
X6 I have done research about their service on Brand XX's website.
X7 I have used Brand XX's catalogue or brochures to actually book their services.
X8 I have used catalogues or printed materials other than Brand XX's to book their services.
X9 I have used Brand XX's own website to book their services.
X10 I have used websites other than Brand XX's to book their services.
X11 I have sampled services from Brand XX.
X12 I have used Brand XX's customer service.
X13 I have used Brand XX's product support.
X14 I have read or seen Brand XX on a blog or online community I visit for pleasure. Separate from advertising, I have read articles or reviews about Brand XX in the media, in
X15 print or online.
X16 I use Brand XX because it was recommended by a friend, colleague or family member.
X17 I know I've seen advertising for Brand XX.
X18 I know I've seen advertising for Brand XX on TV.
X19 I know I've seen advertising for Brand XX on radio.
X20 I know I've seen advertising for Brand XX in magazines or newspapers.
X21 I know I've seen advertising for Brand XX on the Internet.
X22 I know I've seen advertising for Brand XX on billboards or posters.
X23 I've used a search engine (like Google) to learn more about Brand XX.
X24 I have responded to a promotional offer from Brand XX.
X25 I have responded to direct mail sent to my home by Brand XX.
X26 I am a member of Brand XX's loyalty or rewards program.
X27 I received an e-mail from my friend about Brand XX.
X28 I have responded to a promotional e-mail sent to me directly from Brand XX.
X29 I saw Brand XX sponsor or market itself at an event.
X30 I attended a conference or event sponsored by Brand XX.
X31 I have given feedback and suggestions to Brand XX.
X32 I've seen Brand XX in movies or TV shows.
X33 I've seen Brand XX's products or services being used by celebrities.
X34 I've seen people using Brand XX in public.
X35 I have used Brand XX in other stores.
X36 I have been to a main Brand XX office or location.
X37 I use Brand XX's remote service locations, like an ATM.
X38 I use Brand XX's website to manage finances or conduct transactions.

### CB3

T20 Brand XX helps simplify my life.
T21 I rely on Brand XX to get me through everyday life.
T22 Brand XX is good for my health.
T23 Brand XX gives me a sense of well-being.
T24 Brand XX helps me be more productive.
T25 Brand XX helps me meet my responsibilities.
T26 Brand XX helps me be a better parent.
T27 Brand XX helps me perform at a higher level.
T28 Brand XX gives me a feeling of comfort.
T37 Brand XX adds joy and pleasure into my life.
T38 I choose Brand XX when I want to indulge myself.
T39 Using Brand XX is one way that I can reward myself.
T40 Brand XX adds a sense of adventure into my life.
T48 People recognize that I'm doing something positive when I use Brand XX.
T49 I feel more attractive when I use Brand XX.
T50 Brand XX helps me stand out from the crowd.
T51 I feel good telling people I use Brand XX.
T56 Brand XX makes me feel I'm doing something good for my community.
T57 Brand XX makes me feel I'm part of something bigger.
EN7 I look forward to new things from Brand XX.
EN8 People in the know choose Brand XX.
EN21 Brand XX is clearly best in the business.
EN22 The most demanding customers choose Brand XX.
EN23 Brand XX would be a good company to work for.
EN24 Brand XX is an ethical company.
EN25 I am interested in what Brand XX has to say.
EN26 Brand XX can make a real difference in the world.
EN27 Brand XX is a company with a vision.
EN35 I know exactly what Brand XX stands for.
EN36 Brand XX is more than a product, it's an experience.
EN37 People know Brand XX's advertising.
EN44 Brand XX personalizes its relationship with me.
EN45 Brand XX customizes its products and services to the way I want them.
EN46 Brand XX shares my values.
EN50 Brand XX reminds me of when I was younger.
EN51 I primarily buy or use Brand XX's premium products and services.
EX4 Brand XX is easy to do business with.
EX12 Brand XX has a good reputation.
EX13 Brand XX is a brand I trust.
EX14 Brand XX's advertising accurately reflects its products and services.
EX16 The sales and account people at Brand XX are helpful.
EX18 Brand XX is good value for the money.
A5 The Brand XX company has a reputation for reliability.
A8 The Brand XX company will be in business for a long time.
A11 The Brand XX company treats people fairly.
A12 I have no problem telling people I use Brand XX.

### APPENDIX B

### Brands Studied in Validation Study

1) Absolut Vodka
2) Accenture
3) Adidas
4) Aflac
5) Amazon.com
6) Ambien
7) American Airlines
8) American Express
9) Apple Computer
10) Applebee's
11) AT&T Wireless
12) Avis Rent A Car
13) Bank of America
14) Beringer Wines
15) BMW
16) Budweiser
17) Capital One
18) Carnival Cruises
19) Citibank
20) Claritin
21) Coach
22) Coca Cola
23) Comcast
24) CVS
25) Dell
26) DirecTV
27) Disney Theme Parks
28) Dove
29) EBAY.com
30) Ernst & Young
31) Estee Lauder
32) Ethan Allen
33) Federal Express
34) Ford Motor
35) Four Seasons
36) Geico
37) Gillette
38) Google.com
39) Harrah's
40) Heineken
41) Holiday Inn
42) Hewlett Packard
43) Humana
44) Hyundai
45) IBM
46) Lazy Boy
47) Liberty Mutual
48) Lipitor
49) L'Oreal
50) Marlboro
51) Marriott
52) MasterCard
53) McDonalds
54) Microsoft
55) Miracle Gro
56) Nike
57) Nordstrom
58) Northwest Airlines
59) Oracle
60) Panasonic
61) Pepsi
62) Polo Ralph Lauren
63) Ruth's Chris Steakhouse
64) Six Flags
65) Sony
66) Southwest Airlines
67) Starbucks
68) Target
69) Tide
70) Toyota
71) Tylenol
72) United Airlines
73) United Parcel Service
74) Verizon
75) Visa
76) Wachovia
77) Wal Mart
78) Wells Fargo
79) Whirlpool
80) Zappos.com

### APPENDIX C

### Definitions of Independent Variables Used in Validation Study

Loyalty Validation Index: Brand Informatics calculated a loyalty score (the “Interim Loyalty Score”) for each brand listed on Exhibit B. The Interim Loyalty Score was calculated by arithmetically averaging the scores provided by respondents to each Loyalty statement listed on Exhibit A. The Interim Loyalty Scores for the brands listed on Exhibit B were arithmetically averaged to determine the Loyalty Validation Index.
Pricing Power Index: Brand Informatics calculated a pricing power score (the “Interim Pricing Power Score”) for each brand listed on Exhibit B. The Interim Pricing Power Score was calculated by arithmetically averaging the scores provided by respondents to the Pricing Power scale listed on Exhibit A. The Interim Pricing Power Scores for the brands listed on Exhibit B were arithmetically averaged to determine the Pricing Power Index.
Relative Price/Earnings Index: Brand Informatics calculated the difference (“PE Difference”) between the price/earnings multiple, for the brands on Exhibit B, and the average price/earnings multiple for the industry in which each such brand operates. The brands' P/Es were obtained through Hoovers. Industry average P/Es were obtained through Hoovers. A Relative Price/Earnings Index exists brand by brand, and correlation analysis was applied to each statement (one set of variables) and the PE Difference for each brand (second set of variables).
Relative Growth Rate Index: Brand Informatics calculated the difference (“Growth Difference”) between the annual revenue growth rate (2006 fiscal years), for the brands on Exhibit B, and the average annual revenue growth rate (2006 fiscal years) for the industry in which each such brand operates. The brands' revenue growth rates were obtained through Hoovers. Industry average revenue growth rates were obtained through Hoovers. A Relative Growth Rate Index exists brand by brand, and correlation analysis was applied to each statement (one set of variables) and the Growth Difference for each brand (second set of variables).
Relative Gross Margin Index: Brand Informatics calculated the difference (“Gross Margin Difference”) between the gross margins, for the brands on Exhibit B, and the average gross margins for the industry in which each such brand operates. The brands' gross margins were obtained through Hoovers. Industry average gross margins were obtained through Hoovers. A Relative Gross Margin Index exists brand by brand, and correlation analysis was applied to each statement (one set of variables) and the Gross Margin Difference for each brand (second set of variables).
Relative Operating Margin Index: Brand Informatics calculated the difference (“Operating Difference”) between the operating margins (defined as Earnings Before Interest, Taxes, Depreciation, and Amortization (“EBITDA”), as defined by Generally Accepted Accounting Principles (“GAAP”), divided by gross revenue, as defined by GAAP), for the brands on Exhibit B, and the average operating margin for the industry in which each such brand operates. The brands' operating margins were obtained through Hoovers. Industry average operating margins were obtained through Hoovers. A Relative Operating Margin Index exists brand by brand, and correlation analysis was applied to each statement (one set of variables) and the Operating Difference for each brand (second set of variables).
Relative Return on Assets Index: Brand Informatics calculated the difference (“ROA Difference”) between the return on assets, for the brands on Exhibit B, and the average return on assets for the industry in which each such brand operates. The brands' returns on assets were obtained through Hoovers. Industry average returns on assets were obtained through Hoovers. A Relative Return on Assets Index exists brand by brand, and correlation analysis was applied to each statement (one set of variables) and the ROA Difference for each brand (second set of variables).

### APPENDIX D

### Final Statements

1. Using a 1 to 10 scale, where 10 is strongly agree and 1 is strongly disagree, to what extent do you agree or disagree with the following statements? (repeated at top of each page?)
   (INSERT LOYALTY STATEMENTS HERE; ROTATE)
2. Using a 1 to 10 scale, where 10 is strongly agree and 1 is strongly disagree, to what extent do you agree or disagree with the following statements? (repeated at top of each page?)
   (INSERT CB1 STATEMENTS HERE; ROTATE)
3. The next question relates to the value you associate with (INSERT BRAND NAME's) products/services relative to the products/services of competitors. Using the scale below, please indicate the actual market price you expect to pay for (INSERT BRAND NAME's) products/services over, under or equal to the industry average price for similar (classes on products or services.
   Under industry average Over industry average
   −10%−20%−30%−40%−50% Average industry price +10%+20%+30%+40%+50%
4. Using a 1 to 10 scale, where 10 is strongly agree and 1 is strongly disagree, to what extent do you agree or disagree with the following statements? (repeated at top of each page?)
   (INSERT CB2 STATEMENTS HERE; ROTATE)
5. The next section of questions relate to your experiences with (INSERT BRAND) over the last year. Please answer each question based on your experiences over the last year.
   (INSERT EXPERIENCE STATEMENTS HERE; ROTATE)
   1 Yes
   2 No
6. Using a 1 to 10 scale, where 10 is strongly agree and 1 is strongly disagree, to what extent do you agree or disagree with the following statements? (repeated at top of each page?)
   (INSERT CB3 STATEMENTS HERE; ROTATE)
L1 Overall, I am loyal to Brand XX.
L2 I would recommend Brand XX to a friend or colleague.
L4 I use Brand XX most often.
L5 I've tried competitive brands, but have gone back to Brand XX.
L8 I will not switch from Brand XX.
L10 I look for Brand XX first.
L11 I will definitely try the next product or service from Brand XX.
   It would take a significant improvement from another brand to get me to switch from Brand
L13 XX.
L15 I would get upset if Brand XX were not available.
L19 I have gone out of my way to use Brand XX.
L20 Even if Brand XX made a mistake, I would stick with them.
A1 I feel safe using Brand XX.
A3 Brand XX meets industry standards.
A4 I don't have to worry when I use Brand XX.
A5 The Brand XX company has a reputation for reliability.
A6 I have confidence in Brand XX's products and services.
A7 I believe what Brand XX tells me.
A9 Brand XX is a trustworthy company.
A11 The Brand XX company treats people fairly.
EX1 Overall, I am satisfied with Brand XX.
EX3 Brand XX solves problems or issues.
EX 4 Brand XX is easy to do business with.
EX5 Brand XX performs as promised.

EX6 Brand XX is a quality brand.
EX8 Brand XX performs consistently.
EX9 Brand XX is reliable.
EX10 Brand XX products and services are up-to-date.
EX11 Brand XX is stylish.
EX13 Brand XX is a brand I trust.
EX14 Brand XX's advertising accurately reflects its products and services.
EX15 The people at Brand XX are helpful.
EX17 With Brand XX, I get what I pay for.
EX19 People generally consider Brand XX as a good brand.
EX20 Brand XX's sales people are helpful.
EN1 Overall, Brand XX stands out from other brands.
EN2 Brand XX has features and services no one else has.
EN3 Brand XX has the features and services I want most.
EN6 Brand XX always comes out with the best new products and services.
EN7 I look forward to new things from Brand XX.
EN10 Brand XX is a global brand.
EN12 I admire Brand XX as a company.
EN14 Brand XX knows its industry better than anyone.
EN15 Brand XX has strong leaders in the company.
EN16 Brand XX is an innovative brand.
EN17 Brand XX sets the pace for its industry.
EN20 Brand XX is the expert of its industry.
EN21 Brand XX is clearly best in the business.
EN22 The most demanding customers choose Brand XX.
EN24 Brand XX is an ethical company.
EN25 I am interested in what Brand XX has to say.
EN28 Brand XX is authentic and genuine.
EN29 Brand XX has its own style and personality.
EN30 Brand XX is seen as a cool brand.
EN31 Brand XX is in style.
EN35 I know exactly what Brand XX stands for.
EN36 Brand XX is more than a product or service, it's an experience.
EN38 Brand XX understands my lifestyle.
EN41 Brand XX always takes care of its customers.
EN42 Brand XX has my interests at heart.
EN43 People who work at Brand XX are passionate about what they do.
EN44 Brand XX personalizes its relationship with me.
EN45 Brand XX customizes its products and services to the way I want them.
EN47 Brand XX is for people my age.
EN51 I primarily buy or use Brand XX's premium products and services.
T1 I use Brand XX because it makes me feel better.
T2 Brand XX gives me confidence that the future will be better.
T3 Brand XX helps improve life for my family.
T4 Brand XX helps me create a better home life.
T6 Brand XX helps me achieve my personal goals.
T8 Brand XX lets me be myself.
T9 Brand XX helps me live life the way I want to live it.
T11 I share important values with Brand XX.
T12 Brand XX makes me feel sexier.
T15 Brand XX makes me feel younger.
T17 By choosing Brand XX, I've know I've made a smart decision.
T18 By choosing Brand XX, I get a feeling of accomplishment.
T19 Brand XX helps me feel secure.
T20 Brand XX helps simplify my life.
T22 Brand XX is good for my health.
T26 Brand XX helps me be a better parent.
T27 Brand XX helps me perform at a higher level.
T29 I get a feeling of happiness when I use Brand XX.
T30 Brand XX helps me escape from everyday life.
T31 Brand XX gives me a real thrill.
T32 Brand XX is entertaining.
T33 Brand XX helps me feel free and independent.
T38 I choose Brand XX when I want to indulge myself.
T39 Using Brand XX is one way that I can reward myself.
T41 Using Brand XX tells people I'm successful.
T42 I could see myself in a commercial for Brand XX.
T43 Using Brand XX tells something about who I really am.
T45 Brand XX reflects my personal lifestyle.
T49 I feel more attractive when I use Brand XX.
T50 Brand XX helps me stand out from the crowd.
T51 I feel good telling people I use Brand XX.
T52 I feel I've earned the privilege to use Brand XX.
T53 I feel I belong with other people who use Brand XX.
T54 Using Brand XX helps me fit in with friends or colleagues.
T55 By choosing Brand XX I'm also doing something good for society.
T56 Brand XX makes me feel I'm doing something good for my community.
T58 Brand XX gives me a chance to re-connect with family or friends.
L14 I love Brand XX.
X1 I use Brand XX products.
X2 I share my Brand XX experience with others.
X3 I have other products with Brand XX logos on them.
X4 I've dealt with Brand XX's sales people.
X5 I have read or reviewed Brand XX's brochures or other printed information.
X6 I have done research about their service on Brand XX's website.
X7 I have used Brand XX's catalogue or brochures to actually book their services.
X8 I have used catalogues or printed materials other than Brand XX's to book their services.
X9 I have used Brand XX's own website to book their services.
X10 I have used websites other than Brand XX's to book their services.
X11 I have sampled services from Brand XX.
X12 I have used Brand XX's customer service.
X13 I have used Brand XX's product support.
X14 I have read or seen Brand XX on a blog or online community I visit for pleasure. Separate from advertising, I have read articles or reviews about Brand XX in the media, in
X15 print or online.
X16 I use Brand XX because it was recommended by a friend, colleague or family member.
X17 I know I've seen advertising for Brand XX.
X18 I know I've seen advertising for Brand XX on TV.
X19 I know I've seen advertising for Brand XX on radio.
X20 I know I've seen advertising for Brand XX in magazines or newspapers.
X21 I know I've seen advertising for Brand XX on the Internet.
X22 I know I've seen advertising for Brand XX on billboards or posters.
X23 I've used a search engine (like Google) to learn more about Brand XX.
X24 I have responded to a promotional offer from Brand XX.
X25 I have responded to direct mail sent to my home by Brand XX.
X26 I am a member of Brand XX's loyalty or rewards program.
X27 I received an e-mail from my friend about Brand XX.
X28 I have responded to a promotional e-mail sent to me directly from Brand XX.
X29 I saw Brand XX sponsor or market itself at an event.
X30 I attended a conference or event sponsored by Brand XX.
X31 I have given feedback and suggestions to Brand XX.
X32 I've seen Brand XX in movies or TV shows.
X33 I've seen Brand XX's products or services being used by celebrities.
X34 I've seen people using Brand XX in public.
X35 I have used Brand XX in other stores.
X36 I have been to a main Brand XX office or location.
X37 I use Brand XX's remote service locations, like an ATM.
X38 I use Brand XX's website to manage finances or conduct transactions.
X39 I have written about Brand X on a blog.
   I have provided an opinion about Brand X or rated Brand X on a website other than Brand
X40 X's.
X41 I have submitted creative ideas (copy, art, video) about Brand X to the company.
X42 I read information updates Brand X sends me via e-mail.
X43 I subscribe to a magazine published by Brand X for its customers.
X44 I have forwarded information about Brand X to a colleague or friend.
X45 I have used coupons to buy Brand X.

### APPENDIX E

### Screeners

### BANKING SCREENER/QUESTIONNAIRE

1. CONFLICT OF INTEREST QUESTION. Do you or does anyone in your household work for any of the following organizations?
   1 Advertising/public relations firm (TERMINATE/TALLY)
   2 Market research or financial research firm (TERMINATE/TALLY)
   3 Financial services firm such as a bank, insurance or credit card company (TERMINATE/TALLY)
   4 A company or media organization that conducts analysis and reports on banks, insurance companies, credit or any other segment of the financial services industry (TERMINATE/TALLY)
   5 None of the above
2. DECISION MAKER QUESTION. Which of the following statements best describes your involvement in the decision to choose financial products and services used by your household?
   1 Make the final decision yourself
   2 Make the decision jointly with another member of your household
   3 None of the above (TERMINATE/TALLY)
3. CATEGORY CUSTOMER QUESTION. Do you currently have a personal checking, savings, or money market account?
   1 Yes
   2 No (TERMINATE/TALLY)
4. AWARENESS QUESTION. Are you aware of? (ROTATE, INSERT BRANDS)?
   1 Bank of America
   2 Citibank
   3 Wachovia
   4 Wells Fargo
   (IF RESPONDENT IS NOT A WARE OF ANY BRANDS IN Q4, TERMINATE/TALLY)
5a. CUSTOMER-OF QUESTION. Do you currently have a personal checking account, savings account, or money market account with (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. USE QUESTION. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5bb. USE QUESTION. Which of the following products or services do you currently have with (INSERT BRAND BEING EVALUATED FROM Q.5A)
   1 Checking account
   2 Savings account
   3 Money market account
   4 Credit card
   5 Loan
   6 Certificate of deposit (CD)
   7 Brokerage account

### DEMOGRAPHIC QUESTIONS FOLLOW:

7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### CREDIT SCREENER/QUESTIONNAIRE

1. Do you or does anyone in your household work for any of the following organizations?
   1 Advertising/public relations firm (TERMINATE/TALLY)
   2 Market research or financial research firm (TERMINATE/TALLY)
   3 Financial services firm such as a bank, insurance or credit card company (TERMINATE/TALLY)
   4 A company or media organization that conducts analysis and reports on banks, insurance companies, credit or any other segment of the financial services industry (TERMINATE/TALLY)
   5 None of the above
2. Which of the following statements best describes your involvement in the decision to choose financial products and services used by your household?
   1 Make the final decision yourself
   2 Make the decision jointly with another member of your household
   3 None of the above (TERMINATE/TALLY)
3. Do you currently have a credit card that you use for personal use?
   2 Yes
   2 No (TERMINATE/TALLY)
4. Are you aware of? (ROTATE, INSERT BRANDS)?
   5 American Express
   6 Capital One
   7 Mastercard
   8 Visa
   (IF RESPONDENT IS NOT AWARE OF ANY BRANDS IN Q4, TERMINATE/TALLY)
5a. Do you currently have a credit card with (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use your (INSERT BRAND BEING EVALUATED FROM Q.5A) credit card?
   1 Daily
   2 4 to 6 times a week
   3 2 to 3 times a week
   4 Once a week
   5 Once every 2 to 3 weeks
   6 Once a month
   7 Once every 2 to 3 months
   8 Once every 4 to 6 months
   9 Once every 7 to 12 months
   10 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 20
   2 20 to 24
   3 25 to 29
   4 30 to 34
   5 35 to 39
   6 40 to 44
   7 45 to 49
   8 50 to 54
   9 55 to 59
   10 60 to 64
   11 65 to 69
   12 70 to 74
   13 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### INSURANCE SCREENER/QUESTIONNAIRE

1. Do you or does anyone in your household work for any of the following organizations?
   1 Advertising/public relations firm (TERMINATE/TALLY)
   2 Market research or financial research firm (TERMINATE/TALLY)
   3 Financial services firm such as a bank, insurance or credit card company (TERMINATE/TALLY)
   4 A company or media organization that conducts analysis and reports on banks, insurance companies, credit or any other segment of the financial services industry (TERMINATE/TALLY)
   5 None of the above
2. Which of the following statements best describes your involvement in the decision to choose insurance products and services used by your household?
   1 Make the final decision yourself
   2 Make the decision jointly with another member of your household
   3 None of the above (TERMINATE/TALLY)
3. Which of the following types of insurance do you currently have?
   1 Accident or disability insurance
   2 Automobile insurance
   3 Health insurance
   4 Home/renters insurance
   5 Life insurance
   6 None of the above (TERMINATE/TALLY)
4. Are you aware of? (ROTATE, INSERT BRANDS)?
   9 Aflac
   10 Geico
   11 Humana
   12 Liberty Mutual
   (IF RESPONDENT IS NOT A WARE OF ANY BRANDS IN Q4, TERMINATE/TALLY)
5a. Do you currently have an insurance policy with (ROTATE, SHOW BRANDS MENTIONED IN Q.4)?
   2 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5bb. Which of the following types of insurance policies do you currently have with (INSERT BRAND BEING EVALUATED FROM Q.5A)
   1 Accident or disability insurance
   2 Automobile insurance
   3 Health insurance
   4 Home/renters insurance
   5 Life insurance
   6 Other; specify ______
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### AIRLINE SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Airline or travel agency (TERMINATE/TALLY)
   4 Online travel reservation website (TERMINATE/TALLY)
   5 A company or media organization that conducts analysis and reports on the airline or travel business (TERMINATE/TALLY)
   6 None of the above
2. Which of the following statements best describes your involvement in the decision to determine which airlines are used by your household?
   1 Make the final decision yourself
   2 Make the decision jointly with another member of your household
   3 Make the decision jointly with a travel agent
   4 Make the decision jointly with the person in your company responsible for making travel arrangements
   5 None of the above (TERMINATE/TALLY)
3. During the past six months how many times have you flown on a commercial airline for leisure or business purposes?
   1 0 (TERMINATE/TALLY)
   2 1 (TERMINATE/TALLY)
   3 2
   4 3
   5 4
   6 5
   7 6 or more times
4. Are you aware of? (ROTATE, INSERT BRANDS)?
   1 American Airlines
   2 Northwest Airlines
   3 Southwest Airlines
   4 United Airlines
   (IF RESPONDENT IS NOT A WARE OF ANY BRANDS IN Q4, TERMINATE/TALLY)
5a. During the past six months, have you flown on (ROTATE, SHOW BRANDS MENTIONED IN Q.4) for leisure or business purposes?
   3 Yes
   2 No
   (IF NO TO ALL IN Q.5A TERMINATE/TALLY) (IF RESPONDENT INDICATES “YES” TO MORE THAN ONE BRAND IN Q5A, ASSIGN TO BRAND WITH LOWEST COUNT)
5aa. How long ago did you start flying (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you fly (INSERT BRAND BEING EVALUATED FROM Q.5A) for leisure purposes?
   11 Daily
   12 4 to 6 times a week
   13 2 to 3 times a week
   14 Once a week
   15 Once every 2 to 3 weeks
   16 Once a month
   17 Once every 2 to 3 months
   18 Once every 4 to 6 months
   19 Once every 7 to 12 months
   20 Longer than once a year
5bb. How frequently do you fly (INSERT BRAND BEING EVALUATED FROM Q.5A) for business purposes?
   1 Daily
   2 2 to 3 times a week
   3 Once a week
   4 Once every 2 to 3 weeks
   5 Once a month
   6 Once every 2 to 3 months
   7 Once every 4 to 6 months
   8 Once every 7 to 12 months
   9 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### APPAREL SCREENER/QUESTIONNAIRE

### (SEE INCOME REQUIREMENT IN Q.14)

1. Do you or does anyone in your household work for any of the following organizations?
   1 Advertising/public relations firm (TERMINATE/TALLY)
   2 Market research firm (TERMINATE/TALLY)
   3 Clothing, footwear, or accessory manufacturer, wholesaler, or retailer (TERMINATE/TALLY)
   4 Clothing or fashion business (TERMINATE/TALLY)
   5 A company or media organization that conducts analysis and reports on clothing products, footwear, accessories, or fashion (TERMINATE/TALLY)
   6 None of the Above
2. Which of the following statements best describes your involvement in the decision to purchase clothing, footwear, or accessory items such as handbags or neckties for your household?
   1 Make the final decision yourself
   2 Make the decision jointly with another member of your household
   3 None of the above (TERMINATE/TALLY)
3. Have you purchased clothing, footwear, or accessory items during the past month?
   3 Yes
   2 No (TERMINATE/TALLY)
4. Are you aware of? (ROTATE, INSERT BRANDS)?
   1 Adidas
   2 Coach
   3 Nike
   4 Polo
   (IF RESPONDENT IS NOT AWARE OF ANY BRANDS IN Q4, TERMINATE/TALLY)
5a. During the past three months, have you purchased clothing, footwear, or accessory items from (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How often do you use your clothing, footwear, or accessory items from (INSERT BRAND BEING EVALUATED FROM Q.5A)?
   21 Daily
   22 4 to 6 times a week
   23 2 to 3 times a week
   24 Once a week
   25 Once every 2 to 3 weeks
   26 Once a month
   27 Once every 2 to 3 months
   28 Once every 4 to 6 months
   29 Once every 7 to 12 months
   30 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   ****1 Under $35,000 (TERMINATE/TALLY IF POLO CUSTOMER/PROSPECT)
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### AUTOMOBILE SCREENER/QUESTIONNAIRE

### (SEE INCOME REQUIREMENT IN Q.14)

1. Do you or does anyone in your household work for any of the following organizations?
   1 Advertising/public relations firm (TERMINATE/TALLY)
   2 Market research firm (TERMINATE/TALLY)
   3 Automobile manufacturer, supplier, wholesaler, or dealer (TERMINATE/TALLY)
   4 Auto parts, repair, and maintenance (TERMINATE/TALLY)
   5 Businesses engaged in the renting or leasing of automobiles (TERMINATE/TALLY)
   6 A company or media organization that conducts analysis and reports on the automotive industry (TERMINATE/TALLY)
   7 None of the above
2. Which of the following statements best describes your involvement in the decision to purchase or lease an automobile for your household?
   1 Make the final decision yourself
   2 Make the decision jointly with another member of your household
   3 None of the above (TERMINATE/TALLY)
3. Have you purchased or leased a new or used automobile during the past two years?
   4 Yes
   2 No (TERMINATE/TALLY)
4. Are you aware of? (ROTATE, INSERT BRANDS)?
   1 Ford
   2 Hyundai
   3 BMW
   4 Toyota
   (IF RESPONDENT IS NOT A WARE OF ANY BRANDS IN Q4, TERMINATE/TALLY)
5a. During the past two years, have you purchased or leased a new or used (ROTATE, SHOW BRANDS MENTIONED IN Q.4) automobile?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you buy or lease (INSERT BRAND BEING EVALUATED FROM Q.5A) automobiles?
   1 Every 6 months
   2 6 months but less than 1 year
   3 Every year
   4 Every 2 years
   5 Every 3 years
   6 Every 4 to 5 years
   7 Every 6 to 10 years
   8 More than 10 years
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   ****1 Under $35,000 (TERMINATE/TALLY IF BMW CUSTOMER)
   2 $35,000 but less than $50,000 (TERMINATE/TALLY IF BMW CUSTOMER)
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### BUSINESS SERVICES SCREENER 1

1. Do you or does anyone in your household work for any of the following organizations?
   1 Advertising/public relations firm (TERMINATE/TALLY)
   2 Market research firm (TERMINATE/TALLY)
   3 Business, management or technology consulting firm (TERMINATE/TALLY)
   4 Accounting or financial services firm (TERMINATE/TALLY)
   5 A company or media organization that conducts analysis and reports on the technology, accounting, or management consulting industries (TERMINATE/TALLY)
   6 None of the above
2. Which of the following statements best describes your involvement in the decision to select vendors for business consulting or technology consulting for your organization?
   1 Primary decision maker
   2 Significant input into the purchase decision
   3 Little or no influence in the decision (TERMINATE/TALLY)
   4 None of the above (TERMINATE/TALLY)
3. Which of the following business services has your organization purchased during the past six months?
   5 Tax consulting
   6 Audit services
   7 Management consulting
   8 Technology consulting
   9 None of the above (TERMINATE/TALLY)
4. Are you aware of? (ROTATE, INSERT BRANDS)?
   1 Accenture
   2 Ernst & Young
   3 Deloitte
   (RESPONDENT MUST BE A WARE OF ACCENTURE OR ERNST & YOUNG, OTHERWISE, TERMINATE/TALLY)
5a. During the past six months has your organization used any services from (ROTATE, SHOW BRANDS MENTIONED AND AWARE OF IN Q.4)?
   4 Yes
   2 No
   (IF NO TO ACCENTURE AND ERNST & YOUNG, IN Q.5A, TERMINATE/TALL Y) (IF RESPONDENT INDICATES “YES” TO ACCENTURE AND ERNST & YOUNG IN Q5A, ASSIGN TO BRAND WITH LOWEST COUNT)
5aa. How many years has your organization been a customer of (INSERT BRAND BEING EVALUATED FROM Q.5A)?
   1 Less than 1 year
   2 1 to 2 years
   3 3 to 5 years
   4 6 to 10 years
   5 11 to 15 years
   6 16 to 20 years
   7 More than 20 years
5b. How frequently does your organization use services from (INSERT BRAND BEING EVALUATED FROM Q.5A)?
   31 Daily
   32 2 to 3 times a week
   33 Once a week
   34 Once every 2 to 3 weeks
   35 Once a month
   36 Once every 2 to 3 months
   37 Once every 4 to 6 months
   38 Once every 7 to 12 months
   39 Longer than once a year
7. Including all offices and locations, how many people are employed by your organization? (CHECK QUOTAS)
   1 Less than 100
   2 100 to 500
   3 501 to 1,000
   4 More than 1,000
8. Which of the following best describes your title?
   1 President/CEO
   2 COO/Operations Director
   3 CFO/Controller
   4 CIO/IT Director
   5 Procurement Director
   6 Other; specify ______
9. Which of the following best describes the industry in which your organization operates?
   1 Aerospace and defense
   2 Automotive
   3 Banking
   4 Beverages
   5 Business Services
   6 Technology
   7 Construction
   8 Consumer Products
   9 Consumer Services
   10 Education
   11 Electronics
   12 Energy and utilities
   13 Financial services
   14 Food
   15 Government
   16 Healthcare
   17 Industrial Manufacturing
   18 Insurance
   19 Hospitality and Leisure
   20 Media
   21 Real estate
   22 Retail
   23 Telecommunications
   24 Transportation services
10. What are your organization's annual sales?
   1 Less than $5 million
   2 $5 million but less than $10 million
   3 $10 million but less than $25 million
   4 $25 million but less than $50 million
   5 $50 million but less than $100 million
   6 $100 million but less than $250 million
   7 $250 million but less than $500 million
   8 $500 million but less than $1 billion
   9 $1 billion but less than $5 billion
   10 $5 billion or more
11. How long has your organization been in operation?
   1 Less than 1 year
   2 2 to 5 years
   3 6 to 10 years
   4 11 to 20 years
   5 21 to 30 years
   6 longer than 30 years

### BUSINESS SERVICES SCREENER 2

1. Do you or does anyone in your household work for any of the following organizations?
   1 Advertising/public relations firm (TERMINATE/TALLY)
   2 Market research firm (TERMINATE/TALLY)
   3 Shipping, transportation services, or freight business (TERMINATE/TALLY)
   4 A company or media organization that conducts analysis and reports on the shipping, transportation services or freight industries (TERMINATE/TALLY)
   5 None of the Above
2. Which of the following statements best describes your involvement in the decision to select vendors for shipping and freight services for your organization?
   1 Primary decision maker
   2 Significant input into the purchase decision
   3 Little or no influence in the decision (TERMINATE/TALLY)
   4 None of the above (TERMINATE/TALLY)
3. How many times has your organization purchased air or ground delivery service during the past two weeks?
   10 Once
   11 Two to five times
   12 Six to ten times
   13 More than ten times
   14 None of the above (TERMINATE/TALLY)
4. Are you aware of? (ROTATE, INSERT BRANDS)?
   1 Federal Express
   2 UPS
   3 DHL
   (RESPONDENT MUST BE AWARE OF FEDERAL EXPRESS OR UPS, OTHERWISE, TERMINATE/TALLY)
5a. During the past month has your organization used any services from (ROTATE, SHOW BRANDS MENTIONED AND AWARE OF IN Q.4)?
   5 Yes
   2 No
   (IF NO TO FEDERAL EXPRESS AND UPS IN Q.5A, TERMINATE/TALLY) (IF RESPONDENT INDICATES “YES” TO FEDERAL EXPRESS AND UPS IN Q5A, ASSIGN TO BRAND WITH LOWEST COUNT)
5aa. How many years has your organization been a customer of (INSERT BRAND BEING EVALUATED FROM Q.5A)?
   8 Less than 1 year
   9 1 to 2 years
   10 3 to 5 years
   11 6 to 10 years
   12 11 to 15 years
   13 16 to 20 years
   14 More than 20 years
5b. How frequently does your organization use services from (INSERT BRAND BEING EVALUATED FROM Q.5A)?
   40 Daily
   41 2 to 3 times a week
   42 4 to 6 times a week
   43 Once a week
   44 Once every 2 to 3 weeks
   45 Once a month
   46 Once every 2 to 3 months
   47 Once every 4 to 6 months
   48 Once every 7 to 12 months
   49 Longer than once a year
5bb. Which of the following shipping services does your organization regularly purchase from (INSERT BRAND BEING EVALUATED)?
   1 Domestic overnight delivery
   2 International delivery
   3 Ground delivery
7. Including all offices and locations, how many people are employed by your organization? (CHECK QUOTAS)
   1 Less than 100
   2 100 to 500
   3 501 to 1,000
   4 More than 1,000
8. Which of the following best describes your title?
   1 President/CEO
   2 COO/Operations Director
   3 CFO/Controller
   4 CIO/IT Director
   5 Procurement Director
   6 Shipping Director
   7 Warehouse Manager
   8 Other; specify ______
9. Which of the following best describes the industry in which your organization operates?
   25 Aerospace and defense
   26 Automotive
   27 Banking
   28 Beverages
   29 Business Services
   30 Technology
   31 Construction
   32 Consumer Products
   33 Consumer Services
   34 Education
   35 Electronics
   36 Energy and utilities
   37 Financial services
   38 Food
   39 Government
   40 Healthcare
   41 Industrial Manufacturing
   42 Insurance
   43 Hospitality and Leisure
   44 Media
   45 Real estate
   46 Retail
   47 Telecommunications
   48 Transportation services
10. What are your organization's annual sales?
   11 Less than $5 million
   12 $5 million but less than $10 million
   13 $10 million but less than $25 million
   14 $25 million but less than $50 million
   15 $50 million but less than $100 million
   16 $100 million but less than $250 million
   17 $250 million but less than $500 million
   18 $500 million but less than $1 billion
   19 $1 billion but less than $5 billion
   20 $5 billion or more
11. How long has your organization been in operation?
   1 Less than 1 year
   2 2 to 5 years
   3 6 to 10 years
   4 11 to 20 years
   5 21 to 30 years
   6 longer than 30 years

### BUSINESS TECHNOLOGY SCREENER 1

(DEFINITION FOR RESPONDENTS) When you see “technology products” in this survey, it refers to several types of products including computer hardware, printers, scanners, copiers, electronic components, networking equipment, fax machines, servers, general business software, enterprise software, operating system software, and electronic storage devices.
1. Do you or does anyone in your household work for any of the following organizations?
   1 Advertising/public relations firm (TERMINATE/TALLY)
   2 Market research firm (TERMINATE/TALLY)
   3 Technology consulting firm (TERMINATE/TALLY)
   4 Supplier of technology products (as defined) (TERMINATE/TALLY)
   5 A company or media organization that conducts analysis and reports on the technology and IT consulting industries (TERMINATE/TALLY)
   6 None of the Above
2. Which of the following statements best describes your involvement in the decision to select vendors of technology products for your organization?
   1 Primary decision maker
   2 Significant input into the purchase decision
   3 Little or no influence in the decision (TERMINATE/TALLY)
   4 None of the above (TERMINATE/TALLY)
3. Which of the following technology products has your organization purchased during the past six months?
   15 Computers
   16 Software
   17 Printers
   18 Copiers
   19 Fax machines
   20 Networking equipment
   21 Servers
   22 Electronic storage systems
   23 None of the above (TERMINATE/TALLY)
4. Are you aware of? (ROTATE, INSERT BRANDS)?
   1 IBM
   2 Microsoft
   3 Oracle
   4 Hewlett Packard
   (IF RESPONDENT IS NOT AWARE OF ANY BRANDS IN Q4, TERMINATE/TALLY)
5a. During the past six months has your organization purchased any technology products from (ROTATE, SHOW BRANDS MENTIONED AND AWARE OF IN Q.4)?
   6 Yes
   2 No
   (IF NO TO ACCENTURE AND ERNST & YOUNG, IN Q.5A, TERMINATE/TALLY) (IF RESPONDENT INDICATES “YES” TO ACCENTURE AND ERNST & YOUNG IN Q5A, ASSIGN TO BRAND WITH LOWEST COUNT)
5aa. How many years has your organization been a customer of (INSERT BRAND BEING EVALUATED FROM Q.5A)?
   15 Less than 1 year
   16 1 to 2 years
   17 3 to 5 years
   18 6 to 10 years
   19 11 to 15 years
   20 16 to 20 years
   21 More than 20 years
7. Including all offices and locations, how many people are employed by your organization? (CHECK QUOTAS)
   1 Less than 100
   2 100 to 500
   3 501 to 1,000
   4 More than 1,000
8. Which of the following best describes your title?
   1 President/CEO
   2 COO/Operations Director
   3 CFO/Controller
   4 CIO/IT Director
   5 Procurement Director
   6 Other; specify ______
9. Which of the following best describes the industry in which your organization operates?
   49 Aerospace and defense
   50 Automotive
   51 Banking
   52 Beverages
   53 Business Services
   54 Technology
   55 Construction
   56 Consumer Products
   57 Consumer Services
   58 Education
   59 Electronics
   60 Energy and utilities
   61 Financial services
   62 Food
   63 Government
   64 Healthcare
   65 Industrial Manufacturing
   66 Insurance
   67 Hospitality and Leisure
   68 Media
   69 Real estate
   70 Retail
   71 Telecommunications
   72 Transportation services
10. What are your organization's annual sales?
   21 Less than $5 million
   22 $5 million but less than $10 million
   23 $10 million but less than $25 million
   24 $25 million but less than $50 million
   25 $50 million but less than $100 million
   26 $100 million but less than $250 million
   27 $250 million but less than $500 million
   28 $500 million but less than $1 billion
   29 $1 billion but less than $5 billion
   30 $5 billion or more
11. How long has your organization been in operation?
   1 Less than 1 year
   2 2 to 5 years
   3 6 to 10 years
   4 11 to 20 years
   5 21 to 30 years
   6 longer than 30 years

### CPG SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Supplier, manufacturer, retailer or distributor of food, beverage, tobacco, cleaning or detergent product (TERMINATE/TALLY)
   4 A company or media organization that conducts analysis and reports on consumer packaged goods (TERMINATE/TALLY)
   5 None of the above
2. Which of the following statements best describes your involvement in the decision to purchase food, beverage, and cleaning or detergent products for your household?
   1 Make the final decision yourself
   2 Make the decision jointly with another member of your household
   3 None of the above (TERMINATE/TALLY)
3. Have you purchased and used a food, beverage, tobacco, cleaning or detergent product in the last week?
   24 Yes
   2 No (TERMINATE/TALLY)
4. Are you aware of? (ROTATE, INSERT BRANDS)?
   13 Coke
   14 Marlboro
   15 Pepsi
   16 Tide
   (IF RESPONDENT IS NOT A WARE OF ANY BRANDS IN Q4, TERMINATE/TALLY)
5a. During the past two weeks, have you purchased and used a product from (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use products from (INSERT BRAND BEING EVALUATED FROM Q.5A)?
   50 Daily
   51 4 to 6 times a week
   52 2 to 3 times a week
   53 Once a week
   54 Once every 2 to 3 weeks
   55 Once a month
   56 Once every 2 to 3 months
   57 Once every 4 to 6 months
   58 Once every 7 to 12 months
   59 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### ELECTRONICS SCREENER/QUESTIONNAIRE

(DEFINITION FOR RESPONDENTS) When you see “electronics or technology products” in this survey, it refers to several types of consumer products for your self or home including computers, software, cameras/camcorders, DVD players, home theater systems, televisions, radios, telephones, cell phones, printers, gaming systems or games, and portable music players.
1. Do you or does anyone in your household work for any of the following organizations?
   1 Advertising/public relations firm (TERMINATE/TALLY)
   2 Market research firm (TERMINATE/TALLY)
   3 Any manufacturer, wholesaler, or retailer of electronics or technology products (TERMINATE/TALLY)
   4 Home builders, architects or interior designers (TERMINATE/TALLY)
   5 Companies that service, repair or install electronics or technology products or systems (TERMINATE/TALLY)
   6 Suppliers of component parts for electronics or technology products (TERMINATE/TALLY)
   7 A company or media organization that conducts analysis and reports on electronics and technology products (TERMINATE/TALLY)
   8 None of the above
2. Which of the following statements best describes your involvement in the decision to purchase electronics or technology products?
   1 Make the final decision yourself
   2 Make the decision jointly with another member of your household
   3 None of the above (TERMINATE/TALLY)
3. Have you purchased an electronics or technology product during the past six months?
   25 Yes
   2 No (TERMINATE/TALLY)
4. Are you aware of? (ROTATE, INSERT BRANDS)?
   1 Apple
   2 Dell
   3 Panasonic
   4 Sony
   (IF RESPONDENT IS NOT A WARE OF ANY BRANDS IN Q4, TERMINATE/TALLY)
5a. During the past six months have you purchased an electronics or technology product from? (ROTATE, SHOW BRANDS MENTIONED IN Q.4)?
   7 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use electronics or technology products from (INSERT BRAND BEING EVALUATED FROM Q.5A)?
   60 Daily
   61 4 to 6 times a week
   62 2 to 3 times a week
   63 Once a week
   64 Once every 2 to 3 weeks
   65 Once a month
   66 Once every 2 to 3 months
   67 Once every 4 to 6 months
   68 Once every 7 to 12 months
   69 Longer than once a year
5bb. Which of the following products do you currently own from (INSERT BRAND BEING EVALUATED FROM Q.5A)? (CHECKALL THAT APPLY)
   1 TV
   2 DVD player
   3 Home theater system
   4 Stereo system
   5 Portable music system (MP3 player)
   6 PC
   7 PC peripheral (printer)
   8 Camera
   9 Video camera
   10 Gaming system
   11 Telephone
   12 Cell phone
   13 Radio
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### ENTERTAINMENT SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Car rental company, amusement or theme park, cruise line, travel agency or online travel reservation website (TERMINATE/TALLY)
   4 A company or media organization that conducts analysis and reports on the travel or entertainment industries (TERMINATE/TALLY)
   5 None of the Above
2. Which of the following statements best describes your involvement in the decision to select entertainment, recreational, and leisure travel activities for your household?
   1 Make the final decision yourself
   2 Make the decision jointly with another member of your household
   3 None of the above (TERMINATE/TALLY)
3. During the past year, which of the following entertainment and recreational related activities have you engaged in for leisure purposes?
   26 Visited an amusement or theme park
   27 Taken a cruise
   28 Rented an automobile
   4 None of the above (TERMINATE/TALLY)
4. Are you aware of? (ROTATE, INSERT BRANDS)?
   1 Avis Car Rental
   2 Carnival Cruises
   3 Disney Theme Parks
   4 Six Flags Amusement Parks
   (IF RESPONDENT IS NOT AWARE OF ANY BRANDS IN Q4, TERMINATE/TALLY)
5a. During the past year, which of the following activities have you engaged in for leisure purposes (ROTATE, SHOW OPTIONS CORRESPONDING TO RESPONSES MENTIONED IN Q.4)?
   1 Rented an Avis automobile
   2 Taken a Carnival Cruise
   3 Visited a Disney Theme Park
   4 Visited a Six Flags Amusement Park
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you (INSERT LANGUAGE OF BRAND BEING EVALUATED FROM Q.5A) (NOTE: LANGUAGE NEEDS TO BE CUSTOMIZED BY BRAND: RENT A CAR FROM AVIS, TAKE A CARNIVAL CRUISE, VISIT A SIX FLAGS THEME PARK, VISIT A DISNEY THEME PARK?
   70 Daily
   71 4 to 6 times a week
   72 2 to 3 times a week
   73 Once a week
   74 Once every 2 to 3 weeks
   75 Once a month
   76 Once every 2 to 3 months
   77 Once every 4 to 6 months
   78 Once every 7 to 12 months
   79 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### HOME SCREENER/QUESTIONNAIRE

### (PROGRAMMER NOTE: FOR THIS SCREENER WE ARE ONLY INTERESTED IN CONDUCTING INTERVIEWS FOR MIRACLE GRO. NO INTERVIEWS WILL BE CONDUCTED FOR PREEN OR OSCMOCOTE)

1. Do you or does anyone in your household work for any of the following organizations?
   1 Advertising/public relations firm (TERMINATE/TALLY)
   2 Market research firm (TERMINATE/TALLY)
   3 Supplier, manufacturer, retailer of plants, fertilizers, or plant foods/supplements (TERMINATE/TALLY)
   4 Lawn care or landscape company (TERMINATE/TALLY)
   5 A company or media organization that conducts analysis and reports on plants, plant foods, fertilizers, potting mixes, or garden soils (TERMINATE/TALLY)
   6 None of the above
2. Which of the following statements best describes your involvement in the decision to purchase plants, plant foods, potting mix or garden soil for your household?
   1 Make the final decision yourself
   2 Make the decision jointly with another member of your household
   3 None of the above (TERMINATE/TALLY)
3. Have you purchased and used plant food, potting mix, or garden soil during the past month?
   29 Yes
   2 No (TERMINATE/TALLY)
4. Are you aware of? (ROTATE, INSERT BRANDS)?
   17 Miracle Gro
   18 Preen
   19 Oscmocote
   (IF RESPONDENT IS NOT AWARE OF MIRACLE GRO IN Q4, TERMINATE/TALLY)
5a. During the past month, have you purchased and used a product from (ROTATE, SHOW BRANDS MENTIONED IN Q.4)?
   1 Yes
   2 No
   (IF NO TO MIRACLE GRO IN Q.5A, TERMINATE/TALLY)
5aa. How long have you been a customer of Miracle Gro?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. During the outdoor lawn and garden season, how frequently do you use Miracle Gro products?
   80 Daily
   81 4 to 6 times a week
   82 2 to 3 times a week
   83 Once a week
   84 Once every 2 to 3 weeks
   85 Once a month
   86 Once every 2 to 3 months
   87 Once every 4 to 6 months
   88 Once every 7 to 12 months
   89 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### HOME SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Supplier, manufacturer, retailer or service and repair provider of home appliances or furniture (TERMINATE/TALLY)
   4 Home builders, architects or interior designers (TERMINATE/TALLY)
   5 Ownership and Management of Apartments, Home Inspectors, or real estate agents (TERMINATE/TALLY)
   6 A company or media organization that conducts analysis and reports on home products and home interiors (TERMINATE/TALLY)
   7 None of the Above
2. Which of the following statements best describes your involvement in the decision to purchase appliances and furniture for your home?
   1 Make the final decision yourself
   2 Make the decision jointly with another member of your household
   3 None of the above (TERMINATE/TALLY)
3. Have you purchased furniture or an appliance for your home during the past year?
   30 Yes
   2 No (TERMINATE/TALLY)
4. Are you aware of? (ROTATE, INSERT BRANDS)?
   20 Ethan Allen
   21 Lazyboy
   22 Whirlpool
   (IF RESPONDENT IS NOT A WARE OF ANY BRANDS IN Q4, TERMINATE/TALLY)
5a. Currently in your home, do you have furniture or an appliance from (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
   (Skip to Q.7)
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### HOTEL SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Hotel, motel, or casino (TERMINATE/TALLY)
   4 Online travel reservation website (TERMINATE/TALLY)
   5 Travel agency or travel business (TERMINATE/TALLY)
   6 A company or media organization that conducts analysis and reports on the hotel or travel industry (TERMINATE/TALLY)
   7 None of the above
2. Which of the following statements best describes your involvement in the decision to select the hotels your household stays at?
   1 Make the final decision yourself
   2 Make the decision jointly with another member of your household
   3 Make the decision jointly with a travel agent
   4 Make the decision jointly with the person in your company responsible for making travel arrangements
   5 None of the above (TERMINATE/TALLY)
3. During the past six months how many times have you stayed at a hotel for business or leisure purposes?
   1 0 (TERMINATE/TALLY)
   2 1 (TERMINATE/TALLY)
   3 2
   4 3
   5 4
   6 5
   7 6 or more times
4. Are you aware of? (ROTATE, INSERT BRANDS)?
   1 Holiday Inn
   2 Harrah's
   3 Marriott
   4 Four Seasons
   (IF RESPONDENT IS NOT AWARE OF ANY BRANDS IN Q4, TERMINATE/TALLY)
5a. During the past six months, have you stayed at a (ROTATE, SHOW BRANDS MENTIONED IN Q.4) for business or leisure purposes?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you stay at (INSERT BRAND BEING EVALUATED FROM Q.5A) for leisure purposes?
   90 Daily
   91 4 to 6 times a week
   92 2 to 3 times a week
   93 Once a week
   94 Once every 2 to 3 weeks
   95 Once a month
   96 Once every 2 to 3 months
   97 Once every 4 to 6 months
   98 Once every 7 to 12 months
   99 Longer than once a year
5bb. How frequently do you stay at (INSERT BRAND BEING EVALUATED FROM Q.5A) for business purposes?
   1 Daily
   2 2 to 3 times a week
   3 Once a week
   4 Once every 2 to 3 weeks
   5 Once a month
   6 Once every 2 to 3 months
   7 Once every 4 to 6 months
   8 Once every 7 to 12 months
   9 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### INTERNET RETAIL SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Online retailer or auction site (TERMINATE/TALLY)
   4 Traditional retailer or auction firm (TERMINATE/TALLY)
   5 A company or media organization that conducts analysis and reports on online retailing (TERMINATE/TALLY)
   6 None of the above
3. How frequently do you purchase products or services online?
   1 Daily
   2 Weekly
   3 Monthly
   4 Less than monthly (TERMINATE/TALLY)
   5 Never (TERMINATE/TALLY)
4. Are you aware of? (ROTATE, INSERT BRANDS)?
   1 Amazon.com
   2 Ebay.com
   3 Zappos.com
   (IF RESPONDENT IS NOT A WARE OF ANY BRANDS IN Q4, TERMINATE/TALLY)
5a. Which of the following websites have you purchased goods or services from within the past month (ROTATE, SHOW BRANDS MENTIONED IN Q.4)?
   8 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you purchase products or services of (INSERT BRAND BEING EVALUATED FROM Q.5A)?
   100 Daily
   101 4 to 6 times a week
   102 2 to 3 times a week
   103 Once a week
   104 Once every 2 to 3 weeks
   105 Once a month
   106 Once every 2 to 3 months
   107 Once every 4 to 6 months
   108 Once every 7 to 12 months
   109 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### INTERNET SEARCH SCREENER/QUESTIONNAIRE

### (PROGRAMMER NOTE: FOR THIS SCREENER WE ARE ONLY INTERESTED IN CONDUCTING INTERVIEWS FOR GOOGLE. NO INTERVIEWS WILL BE CONDUCTED FOR YAHOO OR AOL)

1. Do you or does anyone in your household work for any of the following organizations?
   1 Advertising/public relations firm (TERMINATE/TALLY)
   2 Market research firm (TERMINATE/TALLY)
   3 Online search engine (TERMINATE/TALLY)
   4 A company that supplies technology for search engines (TERMINATE/TALLY)
   5 A company or media organization that conducts analysis and reports on the Internet (TERMINATE/TALLY)
   6 None of the above
3. How frequently do you use an Internet search engine or portal?
   1 Daily
   2 Weekly
   3 Monthly (TERMINATE/TALLY)
   4 Less than monthly (TERMINATE/TALLY)
   5 Never (TERMINATE/TALLY)
4. Are you aware of? (ROTATE, INSERT BRANDS)?
   1 Google.com
   2 Yahoo.com
   3 AOL.com
   (IF RESPONDENT IS NOT AWARE OF GOOGLE IN Q4, TERMINATE/TALLY)
5a. Which of the following web sites have you used to search for information within the past week (ROTATE, SHOW BRANDS MENTIONED IN Q.4)?
   9 Yes
   2 No
   (IF NO TO GOOGLE IN Q.5A, TERMINATE/TALLY)
5aa. How long have you been a regular user of Google.com?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use Google.com?
   110 Daily
   111 4 to 6 times a week
   112 2 to 3 times a week
   113 Once a week
   114 Once every 2 to 3 weeks
   115 Once a month
   116 Once every 2 to 3 months
   117 Once every 4 to 6 months
   118 Once every 7 to 12 months
   119 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### PERSONAL CARE SCREENER/QUESTIONNAIRE

(DEFINITION FOR RESPONDENTS) When you see “personal care products” in this survey, it refers to several items including shampoo/conditioner, razors, hair styling products, soap, make-up/cosmetics, perfume, cologne, after shave, and skin care items.

### (CHECK GENDER QUOTAS)

1. Do you or does anyone in your household work for any of the following organizations?
   1 Advertising/public relations firm (TERMINATE/TALLY)
   2 Market research firm (TERMINATE/TALLY)
   3 Supplier, manufacturer, or retailer of personal care products (TERMINATE/TALLY)
   4 A company or media organization that conducts analysis and reports on the personal care or health and beauty industries (TERMINATE/TALLY)
   5 None of the above
2. Which of the following statements best describes your involvement in the decision to purchase personal care products for your household?
   1 Make the final decision yourself
   2 Make the decision jointly with another member of your household
   3 None of the above (TERMINATE/TALLY)
3. Have you purchased and used a personal care item during the past month?
   31 Yes
   2 No (TERMINATE/TALLY)
4. Are you aware of? (ROTATE, INSERT BRANDS)?
   23 Dove
   24 Estee Lauder
   25 Gillette
   26 L'Oreal
   (IF RESPONDENT IS NOT AWARE OF ANY BRANDS IN Q4, TERMINATE/TALLY)
5a. During the past month, have you purchased and used a personal care product from (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use personal care products from (INSERT BRAND BEING EVALUATED FROM Q.5A)?
   120 Daily
   121 4 to 6 times a week
   122 2 to 3 times a week
   123 Once a week
   124 Once every 2 to 3 weeks
   125 Once a month
   126 Once every 2 to 3 months
   127 Once every 4 to 6 months
   128 Once every 7 to 12 months
   129 Longer than once a year
7. What is your gender?
   1 Male (TERMINATE/TALLY IF ESTEE LAUDER OR L'OREAL CUSTOMER)
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### PHARMACEUTICALS SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Supplier, manufacturer, or retailer of medicine or prescription drugs (TERMINATE/TALLY)
   4 Any type of healthcare provider, including doctors office, nursing home, outpatient clinic or hospital (TERMINATE/TALLY)
   5 Supplier or manufacturer of biotech products or medical devices (TERMINATE/TALLY)
   6 A company or media organization that conducts analysis and reports on the drug, medical, biotech or healthcare industries (TERMINATE/TALLY)
   7 None of the above
2. Which of the following statements best describes your involvement in the decision to purchase medicine or prescription drugs for your household?
   1 Make the final decision yourself
   2 Make the decision jointly with another member of your household
   3 None of the above (TERMINATE/TALLY)
3. Have you purchased and used any type of oral medicine or prescription drug during the past month?
   32 Yes
   2 No (TERMINATE/TALLY)
4. Are you aware of? (ROTATE, INSERT BRANDS)?
   27 Ambien
   28 Claritin
   29 Lipitor
   30 Tylenol
   (IF RESPONDENT IS NOT A WARE OF ANY BRANDS IN Q4, TERMINATE/TALLY)
5a. During the past month, have you purchased and used any of the following type of medicines (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you take (INSERT BRAND BEING EVALUATED FROM Q.5A)?
   130 Daily
   131 4 to 6 times a week
   132 2 to 3 times a week
   133 Once a week
   134 Once every 2 to 3 weeks
   135 Once a month
   136 Once every 2 to 3 months
   137 Once every 4 to 6 months
   138 Once every 7 to 12 months
   139 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### RESTAURANT SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Restaurant (TERMINATE/TALLY)
   4 Hotel, catering, or food service (TERMINATE/TALLY)
   5 Supplier, manufacturer, or retailer of food products (TERMINATE/TALLY)
   6 A company or media organization that conducts analysis and reports on the restaurant industry (TERMINATE/TALLY)
   7 None of the above
2. Which of the following statements best describes your involvement in the decision to select which restaurants are visited by your household?
   1 Make the final decision yourself
   2 Make the decision jointly with another member of your household
   3 None of the above (TERMINATE/TALLY)
3. Have you eaten at a restaurant two or more times during the past two weeks?
   33 Yes
   2 No (TERMINATE/TALLY)
4. Are you aware of? (ROTATE, INSERT BRANDS)?
   1 McDonalds
   2 Ruth's Chris Steakhouse
   3 Starbucks
   4 Applebees
   (IF RESPONDENT IS NOT AWARE OF ANY BRANDS IN Q4, TERMINATE/TALLY)
5a. During the past month have you eaten at or ordered food from (ROTATE, SHOW BRANDS MENTIONED IN Q.4)?
   1 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you eat at or order food from (INSERT BRAND BEING EVALUATED FROM Q.5A)?
   140 Daily
   141 4 to 6 times a week
   142 2 to 3 times a week
   143 Once a week
   144 Once every 2 to 3 weeks
   145 Once a month
   146 Once every 2 to 3 months
   147 Once every 4 to 6 months
   148 Once every 7 to 12 months
   149 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### RETAIL SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Any retailer such as a department store, mass merchandiser, or drug store (TERMINATE/TALLY)
   4 Any online or catalog retailer (TERMINATE/TALLY)
   5 A company or media organization that conducts analysis and reports on retail (TERMINATE/TALLY)
   6 None of the above
3. Have you made a purchase at a retail store such as a department store, mass merchandiser, or drug store during the past month?
   34 Yes
   2 No (TERMINATE/TALLY)
4. Are you aware of? (ROTATE, INSERT BRANDS)?
   1 CVS
   2 Nordstrom
   3 Target
   4 Wal-Mart
   (IF RESPONDENT IS NOT AWARE OF ANY BRANDS IN Q4, TERMINATE/TALLY)
5a. Which of the following retailers have you purchased from during the past month (ROTATE, SHOW BRANDS MENTIONED IN Q.4)?
   10 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you purchase from (INSERT BRAND BEING EVALUATED FROM Q.5A)?
   150 Daily
   151 4 to 6 times a week
   152 2 to 3 times a week
   153 Once a week
   154 Once every 2 to 3 weeks
   155 Once a month
   156 Once every 2 to 3 months
   157 Once every 4 to 6 months
   158 Once every 7 to 12 months
   159 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### TELECOMMUNICATION SCREENER/QUESTIONNAIRE

(DEFINITION FOR RESPONDENTS) When you see “telecommunication products and services” in this survey, it refers to several types of products and services including cell phone service, Internet access; local phone service, long distance phone service, and satellite or cable television.
1. Do you or does anyone in your household work for any of the following organizations?
   1 Advertising/public relations firm (TERMINATE/TALLY)
   2 Market research firm (TERMINATE/TALLY)
   3 Any manufacturer, wholesaler, or retailer of telecommunication products and services (TERMINATE/TALLY)
   4 Electricity or energy utilities (TERMINATE/TALLY)
   5 A company or media organization that conducts analysis and reports on the telecommunications industry (TERMINATE/TALLY)
   6 None of the above
2. Which of the following statements best describes your involvement in the decision to purchase telecommunication products and services for your household?
   1 Make the final decision yourself
   2 Make the decision jointly with another member of your household
   3 None of the above (TERMINATE/TALLY)
3. Which of the following telecommunication products and services do you currently use?
   35 Local telephone service
   36 Long distance telephone service
   37 Internet access
   38 Cell phone
   39 Satellite or cable television
   6 None of the above (TERMINATE/TALLY)
   (RESPONDENTS MUST MENTION AT LEAST TWO TELECOMMUNICATION PRODUCTS IN ORDER TO QUALIFY, OTHERWISE TERMINATE)
4. Are you aware of? (ROTATE, INSERT BRANDS)?
   1 AT&T Wireless
   2 Comcast
   3 DirectTV
   4 Verizon
   (IF RESPONDENT IS NOT A WARE OF ANY BRANDS IN Q4, TERMINATE/TALLY)
5a. Outside of your workplace, do you currently use any telecommunication products or services from? (ROTATE, SHOW BRANDS MENTIONED IN Q.4)?
   11 Yes
   2 No
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you use telecommunication products and services from (INSERT BRAND BEING EVALUATED FROM Q.5A)?
   160 Daily
   161 4 to 6 times a week
   162 2 to 3 times a week
   163 Once a week
   164 Once every 2 to 3 weeks
   165 Once a month
   166 Once every 2 to 3 months
   167 Once every 4 to 6 months
   168 Once every 7 to 12 months
   169 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

### WINE/SPIRIT SCREENER/QUESTIONNAIRE

1. Do you or does anyone in your household work for any of the following organizations?
   1 Advertising/public relations firm (TERMINATE/TALLY)
   2 Market research firm (TERMINATE/TALLY)
   3 Supplier, manufacturer, or distributor of wines and spirits (TERMINATE/TALLY)
   4 Restaurants, Bars, Hotels, Casinos, Cruise Lines or Other entertainment venues serving wine & spirits (TERMINATE/TALLY)
   5 Caterers or event planners (TERMINATE/TALLY)
   6 Retailer (TERMINATE/TALLY)
   7 A company or media organization that conducts analysis and reports on food & beverage and wine & spirit products (TERMINATE/TALLY)
   8 None of the above
3. Have you purchased and consumed an alcoholic beverage during the past week?
   40 Yes
   2 No (TERMINATE/TALLY)
4. Are you aware of? (ROTATE, INSERT BRANDS)?
   31 Absolut
   32 Berringer
   33 Budweiser
   34 Heineken
   (IF RESPONDENT IS NOT AWARE OF ANY BRANDS IN Q4, TERMINATE/TALLY)
5a. During the past month, have you purchased and consumed (ROTATE, SHOW OPTIONS CORRESPONDING TO RESPONSES MENTIONED IN Q.4)
   1 A bottle or mixed drink with Absolut
   2 A bottle or glass of Berringer wine
   3 A bottle or glass of Budweiser beer
   4 A bottle or glass of Heineken beer
   (IF NO TO ALL IN Q.5A, TERMINATE/TALLY) (IF RESPONDENT INDICATES “YES” TO MORE THAN ONE BRAND IN Q5A, ASSIGN TO BRAND WITH LOWEST COUNT)
5aa. How long have you been a customer of (INSERT BRAND BEING EVALUATED FROM Q.5A)?
   1 Less than 6 months
   2 6 months but less than 1 year
   3 1 to 2 years
   4 3 to 5 years
   5 6 to 10 years
   6 11 to 15 years
   7 16 to 20 years
   8 More than 20 years
5b. How frequently do you drink (INSERT BRAND BEING EVALUATED FROM Q.5A)?
   170 Daily
   171 4 to 6 times a week
   172 2 to 3 times a week
   173 Once a week
   174 Once every 2 to 3 weeks
   175 Once a month
   176 Once every 2 to 3 months
   177 Once every 4 to 6 months
   178 Once every 7 to 12 months
   179 Longer than once a year
7. What is your gender?
   1 Male
   2 Female
8. What is your marital status?
   1 Married
   2 Single, never married
   3 Divorced, widowed, separated
   4 Living with partner
9. How many children under the age of 18 live in your household?
   1 None
   2 One
   3 Two
   4 Three
   5 Four or more
10. Which of the following best describes the highest level of education that you completed?
   1 Some high school or less
   2 High school degree
   3 Some college
   4 College degree
   5 Graduate work/degree
11. Which of the following best describes your age?
   1 Under 18 (TERMINATE/TALLY)
   2 18 to 19
   3 20 to 24
   4 25 to 29
   5 30 to 34
   6 35 to 39
   7 40 to 44
   8 45 to 49
   9 50 to 54
   10 55 to 59
   11 60 to 64
   12 65 to 69
   13 70 to 74
   14 75 or older
12. What is your employment status?
   1 Employed full time
   2 Employed part time
   3 Homemaker
   4 Student
   5 Retired
   6 Not currently employed
   7 Self employed
13. Which of the following best describes your ethnicity?
   1 White
   2 African-American
   3 Hispanic
   4 Asian
   5 Other
14. Which of the following best describes your total annual household income before taxes?
   1 Under $35,000
   2 $35,000 but less than $50,000
   3 $50,000 but less than $75,000
   4 $75,000 but less than $100,000
   5 $100,000 but less than $125,000
   6 $125,000 but less than $150,000
   7 $150,000 but less than $200,000
   8 $200,000 or higher
15. What state do you currently live in?
   1 Alabama
   2 Alaska
   3 Arizona
   4 Arkansas
   5 California
   6 Colorado
   7 Connecticut
   8 District of Columbia
   9 Delaware
   10 Florida
   11 Georgia
   12 Hawaii
   13 Idaho
   14 Illinois
   15 Indiana
   16 Iowa
   17 Kansas
   18 Kentucky
   19 Louisiana
   20 Maine
   21 Maryland
   22 Massachusetts
   23 Michigan
   24 Minnesota
   25 Mississippi
   26 Missouri
   27 Montana
   28 Nebraska
   29 Nevada
   30 New Hampshire
   31 New Jersey
   32 New Mexico
   33 New York
   34 North Carolina
   35 North Dakota
   36 Ohio
   37 Oklahoma
   38 Oregon
   39 Pennsylvania
   40 Rhode Island
   41 South Carolina
   42 South Dakota
   43 Tennessee
   44 Texas
   45 Utah
   46 Vermont
   47 Virginia
   48 Washington
   49 West Virginia
   50 Wisconsin
   51 Wyoming
16. What is the zip code of your primary residence? ______

APPENDIX F
Population Quotas

| | | | Brand | Brand |
|---|---|---|---|---|
| | | 2000 | Informatics | Informatics |
| | | Census | Minimum | Maximum |
| Gender | Male | 48% | 45% | 51% |
| | Female | 52% | 49% | 55% |
| Age | 18-24 | 13% | 10% | 16% |
| | 25-34 | 19% | 16% | 22% |
| | 35-44 | 22% | 19% | 25% |
| | 45-54 | 18% | 15% | 21% |
| | 55+ | 28% | 25% | 31% |
| Ethnicity | Caucasian | 75% | 70% | 80% |
| | Non- | 25% | 20% | 30% |
| | Caucasian | | | |

APPENDIX G
Connection and Loyalty Weights

| | | Correlations | Wts |
|---|---|---|---|
| | Assumptions | | |
| 1 | Overall, I find Brand XX to be safe and trustworthy. | 0.561 | 0.130 |
| 3 | Brand XX meets industry standards. | 0.527 | 0.122 |
| 4 | I don't have to worry when I use Brand XX. | 0.535 | 0.124 |
| 5 | The Brand XX company has a reputation for reliability. | 0.516 | 0.119 |
| 6 | I have confidence in Brand XX's products and services. | 0.617 | 0.143 |
| 7 | I believe what Brand XX tells me. | 0.525 | 0.121 |
| 9 | Brand XX is a trustworthy company. | 0.562 | 0.130 |
| 11 | The Brand XX company treats people fairly. | 0.483 | 0.112 |
| | | 4.326 | 1 |
| | Enhancement | | |
| 1 | Overall, Brand XX stands out from other brands. | 0.703 | 0.047 |
| 2 | Brand XX has features and services no one else has. | 0.623 | 0.0417 |
| 3 | Brand XX has the features and services I want most. | 0.687 | 0.0460 |
| 6 | Brand XX always comes out with the best new products/services. | 0.627 | 0.0420 |
| 7 | I look forward to new things from Brand XX. | 0.586 | 0.0392 |
| 12 | I admire Brand XX as a company. | 0.612 | 0.0410 |
| 14 | Brand XX knows its industry better than anyone. | 0.652 | 0.0436 |
| 15 | Brand XX has strong leaders in the company. | 0.523 | 0.0350 |
| 16 | Brand XX is always ahead of the curve. | 0.610 | 0.0408 |
| 17 | Brand XX sets the pace for its industry. | 0.602 | 0.0403 |
| 20 | Brand XX is the expert of its industry. | 0.590 | 0.0395 |
| 21 | Brand XX is clearly best in the business. | 0.653 | 0.0437 |
| 22 | The most demanding customers choose Brand XX. | 0.568 | 0.0380 |
| 25 | I am interested in what Brand XX has to say. | 0.560 | 0.0375 |
| 28 | Brand XX is authentic and genuine. | 0.605 | 0.0405 |
| 29 | Brand XX has its own style and personality. | 0.541 | 0.0362 |
| 30 | Brand XX is seen as a cool brand. | 0.535 | 0.0358 |
| 31 | Brand XX is in style. | 0.494 | 0.0331 |
| 36 | Brand XX is more than a product, it's an experience. | 0.520 | 0.0348 |
| 38 | Brand XX understands my lifestyle. | 0.545 | 0.0365 |
| 41 | Brand XX always takes care of its customers | 0.544 | 0.0364 |
| 42 | Brand XX has my interests at heart. | 0.536 | 0.0359 |
| 43 | People who work at Brand XX are passionate about what they do. | 0.505 | 0.0338 |
| 44 | Brand XX personalizes its relationship with me. | 0.470 | 0.0315 |
| 45 | Brand XX customizes its products/services to the way I want them. | 0.539 | 0.0361 |
| 47 | Brand XX is for people my age. | 0.509 | 0.0341 |
| | | 14.939 | 1.000 |
| | Expectations | | |
| 1 | Overall, I am satisfied with Brand XX. | 0.618 | 0.0842 |
| 3 | Brand XX solves problems or issues. | 0.408 | 0.0556 |
| 4 | Brand XX is easy to do business with. | 0.483 | 0.0658 |
| 5 | Brand XX performs as promised. | 0.590 | 0.0804 |
| 6 | Brand XX is a quality brand. | 0.576 | 0.0785 |
| 9 | Brand XX is reliable. | 0.547 | 0.0745 |
| 10 | Brand XX products and services are up-to-date. | 0.554 | 0.0755 |
| 11 | Brand XX is stylish. | 0.464 | 0.0632 |
| 13 | Brand XX is a brand I trust. | 0.565 | 0.0770 |
| 14 | Brand XX's advertising accurately reflects its products/services. | 0.527 | 0.0718 |
| 15 | The people at Brand XX are helpful. | 0.487 | 0.0663 |
| 17 | With Brand XX, I get what I pay for. | 0.598 | 0.0815 |
| 19 | People generally consider Brand XX as a good brand. | 0.522 | 0.0711 |
| 20 | Brand XX's sales people are helpful. | 0.401 | 0.0546 |
| | | 7.340 | 1.0000 |
| | Loyalty | | |
| 1 | Overall, I am loyal to Brand XX. | 0.835 | 0.102 |
| 2 | I would recommend Brand XX to a friend or colleague. | 0.709 | 0.087 |
| 4 | I use Brand XX most often. | 0.711 | 0.087 |
| 5 | I've tried competitive brands, but have gone back to Brand XX. | 0.638 | 0.078 |
| 8 | I will not switch from Brand XX. | 0.788 | 0.096 |
| 10 | I look for Brand XX first. | 0.830 | 0.101 |
| 11 | I will definitely try the next product or service from Brand XX. | 0.688 | 0.084 |
| 13 | Take a significant improvement from other brand to switch | 0.758 | 0.093 |
| 15 | I would get upset if Brand XX was not available. | 0.767 | 0.094 |
| 19 | I have gone out of my way to use Brand XX. | 0.755 | 0.092 |
| 20 | Even if Brand XX made a mistake, I would stick with them. | 0.707 | 0.086 |
| | | 8.186 | 1.000 |
| | Transformation | | |
| 1 | I use Brand XX because it makes me feel better. | 0.606 | 0.042 |
| 2 | Brand XX gives me confidence that the future will be better. | 0.509 | 0.035 |
| 3 | Brand XX helps improve life for my family. | 0.477 | 0.033 |
| 6 | Brand XX helps me achieve my personal goals. | 0.471 | 0.033 |
| 8 | Brand XX lets me be myself. | 0.528 | 0.036 |
| 9 | Brand XX helps me live life the way I want to live it. | 0.527 | 0.036 |
| 11 | I share important values with Brand XX. | 0.510 | 0.035 |
| 17 | By choosing Brand XX, I've know I've made a smart decision. | 0.623 | 0.043 |
| 18 | By choosing Brand XX, I get a feeling of accomplishment. | 0.518 | 0.036 |
| 19 | Brand XX helps me feel secure. | 0.445 | 0.031 |
| 20 | Brand XX helps simplify my life. | 0.459 | 0.032 |
| 27 | Brand XX helps me perform at a higher level. | 0.448 | 0.031 |
| 29 | I get a feeling of happiness when I use Brand XX. | 0.591 | 0.041 |
| 31 | Brand XX gives me a real thrill. | 0.532 | 0.037 |
| 32 | Brand XX is entertaining. | 0.467 | 0.032 |
| 33 | Brand XX helps me feel free and independent. | 0.465 | 0.032 |
| 38 | I choose Brand XX when I want to indulge myself. | 0.489 | 0.034 |
| 39 | Using Brand XX is one way that I can reward myself. | 0.533 | 0.037 |
| 41 | Using Brand XX tells people I'm successful. | 0.472 | 0.033 |
| 42 | I could see myself in a commercial for Brand XX. | 0.480 | 0.033 |
| 43 | Using Brand XX tells something about who I really am. | 0.537 | 0.037 |
| 45 | Brand XX reflects my personal lifestyle. | 0.511 | 0.035 |
| 50 | Brand XX helps me stand out from the crowd. | 0.451 | 0.031 |
| 51 | I feel good telling people I use Brand XX. | 0.567 | 0.039 |
| 52 | I feel I've earned the privilege to use Brand XX. | 0.507 | 0.035 |
| 53 | I feel I belong with other people who use Brand XX. | 0.525 | 0.036 |
| 55 | By choosing Brand XX I'm also doing something good for society. | 0.450 | 0.031 |
| L14 | I love Brand XX. | 0.771 | 0.053 |
| | | 14.469 | 1 |

### APPENDIX H

We claim:

1. A computer implemented method of validating an effectiveness of a candidate survey question in measuring at least one attribute associated with a plurality of studied subjects, comprising:
collecting from each of n number of responders through a computer network, n being an integer, a plurality of sets of responses to a set of survey questions, said set of survey questions including said candidate survey question, each of said set of survey questions soliciting a numerical value response, each set of said plurality of sets of responses respectively corresponding to responses to said set of survey questions with respect to one of said plurality of studied subjects;
determining, with at least one processor, n first average values, each of said n first average values being an arithmetic average of all responses to each of said set of survey questions with respect to each of said plurality of studied subjects, from an i^{th} one of said n responders, said i being an integer ranging from 1 to n;
determining, with the at least one processor, a correlation coefficient for said candidate survey question using a formula,
correlation coefficient=[Σ(variations from mean value for var₁)×Σ(variations from mean value for var₂)]/[total number of responders×standard deviation of both var₁ and var₂],
wherein said var₁ represents n responses to said candidate survey question, and wherein said var₂ is said n first average values; and
determining, with the at least one processor, said effectiveness based on said correlation coefficient.

2. The computer implemented method of validating the effectiveness of the candidate survey question as set forth in claim 1, wherein the formula for determining the correlation coefficient comprises:
$$r = \frac{\sum XY - \frac{\sum X \sum Y}{N}}{\sqrt{( \sum {X}^{2} - \frac{{( \sum X )}^{2}}{N} ) ( \sum {Y}^{2} - \frac{{( \sum Y )}^{2}}{N} )}} ,$$
wherein said X represents n responses to said candidate survey question, and wherein said Y is said n first average values.

3. A computer implemented method of measuring performance quality of a measured brand, comprising:
receiving, from a plurality of responders through a computer network, responses to a set of survey questions, wherein said set of survey questions comprises n subsets of questions, n being an integer, each of said n subsets questions being intended to measure respectively corresponding one of n attributes of said measured brand;
assigning, by operation of at least one processor, for each of said n attributes, a score based on responses to respective corresponding one of said n subsets of questions,
wherein said n attributes comprises:
a connection attribute relating to perceived quality associated with said measured brand, and
a loyalty attribute relating to loyalty towards said measured brand.

4. The computer implemented method of measuring performance quality of said measured brand as set forth in claim 3, wherein said n attributes further comprises:
an experience attribute relating to an existence of one or more experiences while using products of said measured brand.

5. The computer implemented method of measuring performance quality of said measured brand as set forth in claim 4, wherein said n attributes further comprises:
a pricing power attribute relating to perceived fair price on a sliding scale associated with said measured brand.

6. The computer implemented method of measuring performance quality of said measured brand as set forth in claim 3, wherein said connection attributes further comprises:
a transformation connection attribute relating to perceived improvement of quality of life by said measured brand;
an enhancement connection attribute relating to perceived unique benefits offered by said measured brand;
an expectation connection attribute relating to perceived satisfaction of expected quality of said measured brand; and
an assumption connection attribute relating to perceived trustworthiness associated with said measured brand.

7. The computer implemented method of measuring performance quality of said measured brand as set forth in claim 3, wherein said set of survey questions were asked with respect to a plurality of brands including said measured brand, wherein said step of assigning said score comprises:
determining a correlation coefficient for each question of respective one of said n subsets of questions corresponding to i^{th} one of said n attributes using a formula,
correlation coefficient for m^{th} question=[Σ(variations from mean value for var₁)×Σ(variations from mean value for var₂)]/[total number of responders×standard deviation of both var₁ and var₂],
wherein said m is an integer between 1 and a total number of questions in said subset of questions, wherein said var₁ represents responses to said each question of corresponding one of said n subsets of questions, and wherein said var₂ is arithmetic average of responses to all questions of said subset of questions with respect to all of said plurality of brands; and
assigning as said score a weighted average of all responses to said respective one of said n subsets of questions, wherein said correlated coefficient is used as a proportional weight.

8. The computer implemented method of measuring performance quality of said measured brand as set forth in claim 5, further comprising:
plotting, by said at least one processor, each score for a first one through an (n−1)^{th} one of said n attributes respectively on a first one thought an m^{th} one of a plurality of axes to obtain each a first through (n−1)^{th} coordinates, said m being an integer;
rotating, by said at least one processor, at least one of said plurality axes by a rotation amount, said rotation amount corresponding to an n^{th} one of said n attributes; and
drawing, by said at least one processor, at least one three dimensional geometrical shape using each of said first through (n−1)^{th} coordinates as nodal points of said at least one three dimensional geographical shape.

9. The computer implemented method of measuring performance quality of said measured brand as set forth in claim 8, wherein:
said at least one three dimensional geometrical shape comprises a polygon having said first through (n−1)^{th} coordinates as vertices.

10. The computer implemented method of measuring performance quality of said measured brand as set forth in claim 9, wherein:
said n is four, and wherein said at least one three dimensional geometrical shape comprises a tetrahedron having only said first through (n−1)^{th} coordinates as vertices.

11. The computer implemented method of measuring performance quality of said measured brand as set forth in claim 7, wherein said connection attribute further comprises:
a transformation connection attribute relating to perceived improvement of quality of life by said measured brand;
an enhancement connection attribute relating to perceived unique benefits offered by said measured brand;
an expectation connection attribute relating to perceived satisfaction of expected quality of said measured brand; and
an assumption connection attribute relating to perceived trustworthiness and safety associated with said measured brand,
wherein said score for said connection attribute comprises a total connection score, said total connection score being determined using following formula:
total connection score=Σ(score for assumption connection, if ≧6);
(score for expectation connection if ≧6 and score for assumption connection ≧6);
(score for enhancement connection if ≧7 and score for expectation connection ≧6 and score for assumption connection ≧6);
(score for transformation connection if ≧7 and score for enhancement connection, if ≧7, score for expectation connection, if ≧6 and score for assumption connection, if ≧6).

12. A computer implemented method of conveying information of a plurality of attributes, comprising:
plotting, by at least one processor, each of a first one through an n^{th} one of said plurality of attributes respectively on a first one thought an m^{th} one of a plurality of axes to obtain each a first through n^{th} coordinates, each of said n and m being an integer;
rotating, by the at least one processor, at least one of said plurality axes by a rotation amount, said rotation amount corresponding to a (n+1)^{th} one of said plurality of attributes; and
drawing, by the at least one processor, at least one three dimensional geometrical shape using each of said first through n^{th} coordinates as nodal points of said at least one three dimensional geographical shape.

13. The computer implemented method of conveying information as set forth in claim 12, wherein:
said n is four, and wherein said at least one three dimensional geometrical shape comprises a tetrahedron having only said first through (n−1)^{th} coordinates as vertices.

14. A machine readable storage medium having stored therein one or more instructions for implementing a method of measuring performance quality of a measured brand, said one or more instructions comprising instructions for:
receiving from a plurality of responders responses to a set of survey questions, wherein said set of survey questions comprises n subsets of questions, n being an integer, each of said n subsets questions being intended to measure respectively corresponding one of n attributes of said measured brand;
assigning for each of said n attributes, a score based on responses to respective corresponding one of said n subsets of questions,
wherein said n attributes comprises:
a connection attribute relating to perceived quality associated with said measured brand, and
a loyalty attribute relating to loyalty towards said measured brand.

15. The machine readable storage medium according, to claim 14, wherein said n attributes further comprises:
an experience attribute relating to an existence of one or more experiences while using products of said measured brand.

16. The machine readable storage medium according to claim 15, wherein said n attributes further comprises:
a pricing power attribute relating to perceived fair price on a sliding scale associated with said measured brand.

17. The machine readable storage medium according to claim 14, wherein said connection attributes further comprises:
a transformation connection attribute relating to perceived improvement of quality of life by said measured brand;
an enhancement connection attribute relating to perceived unique benefits offered by said measured brand;
an expectation connection attribute relating to perceived satisfaction of expected quality of said measured brand; and
an assumption connection attribute relating to perceived trustworthiness associated with said measured brand.

18. The machine readable storage medium according to claim 14, wherein said set of survey questions were asked with respect to a plurality of brands including said measured brand, and wherein said one or more instructions further comprises instructions for:
determining a correlation coefficient for each question of respective one of said n subsets of questions corresponding to i^{th} one of said n attributes using a formula,
correlation coefficient for m^{th} question=[Σ(variations from mean value for var₁)×Σ(variations from mean value for var₂)]/[total number of responders×standard deviation of both var₁ and var₂],
wherein said m is an integer between 1 and a total number of questions in said subset of questions, wherein said var₁ represents responses to said each question of corresponding one of said n subsets of questions, and wherein said var₂ is arithmetic average of responses to all questions of said subset of questions with respect to all of said plurality of brands; and
assigning as said score a weighted average of all responses to said respective one of said n subsets of questions, wherein said correlated coefficient is used as a proportional weight.

19. The machine readable storage medium according to claim 16, wherein said one or more instructions further comprises instructions for:
plotting each score for a first one through an (n−1)^{th} one of said n attributes respectively on a first one thought an m^{th} one of a plurality of axes to obtain each a first through (n−1)^{th} coordinates, said m being an integer;
rotating at least one of said plurality axes by a rotation amount, said rotation amount corresponding to an n^{th} one of said n attributes; and
drawing at least one three dimensional geometrical shape using each of said first through (n−1)^{th} coordinates as nodal points of said at least one three dimensional geographical shape.

20. The machine readable storage medium according to claim 16, wherein said one or more instructions further comprises instructions for:
plotting along a first axis a first score associated with said connection attribute;
plotting along a second axis a second score and a third score associated with said experience attribute;
plotting along a third axis a fourth score associated with said loyalty attribute;
rotating said third axis by a rotation amount corresponding to a fifth score associated with said pricing power attribute; and
drawing a tetrahedron by using the first through fourth scores as vertices.

21. A system for measuring performance quality of a measured brand, comprising:
a data collection server configured to store, responses of a plurality of responders, to a set of survey questions, wherein said set of survey question comprises n subsets of questions, n being an integer, each of said n subsets questions being intended to measure respectively corresponding one n attributes of said measured brand;
an analytics server in communicative connection with said data collection server, said analytics server being configured to assign, for each of said n attributes, a score based on responses to respective corresponding one of said n subsets of questions,
a graphics server in communicative connection with said analytics server, said graphics server configured to generate a visual representation of said scores for said n attributes, said graphics server including a machine readable storage medium having stored therein one or more instructions for:
plotting each score for a first one through an (n−1)^{th} one of said n attributes respectively on a first one thought an m^{th} one of a plurality of axes to obtain each a first through (n−1)^{th} coordinates, said m being an integer,
rotating at least one of said plurality axes by a rotation amount, said rotation amount corresponding to an n^{th} one of said n attributes, and
drawing at least one three dimensional geometrical shape using each of said first through (n−1)^{th} coordinates as nodal points of said at least one three dimensional geographical shape.

22. The system for measuring performance quality of said measured brand according to claim 21, wherein:
said at least one three dimensional geometrical shape comprises a polygon having said first through (n−1)^{th} coordinates as vertices.

23. The system for measuring performance quality of said measured brand according to claim 11, wherein:
said n is 4, and wherein said at least one three dimensional geometrical shape comprises a tetrahedron having only said first through (n−1)^{th} coordinates as vertices.

24. The system for measuring performance quality of said measured brand according to claim 23, wherein said n attributes comprises:
a connection attribute relating to perceived quality associated with said measured brand, and
a loyalty attribute relating to loyalty towards said measured brand.

25. The system for measuring performance quality of said measured brand according to claim 24, wherein said n attributes further comprises:
an experience attribute relating to an existence of one or more experiences while using products of said brand.

26. The system for measuring performance quality of said measured brand according to claim 25, wherein said n attributes further comprises:
a pricing power attribute relating to perceived fair price on a sliding scale associated with said measured brand.

27. The system for measuring performance quality of said measured brand as set forth in claim 26, wherein said connection attributes further comprises:
a transformation connection attribute relating to perceived improvement of quality of life by said measured brand;
an enhancement connection attribute relating to perceived unique benefits offered by said measured brand;
an expectation connection attribute relating to perceived satisfaction of expected quality of said measured brand; and
an assumption connection attribute relating to perceived trustworthiness associated with said measured brand,
wherein said score for said connection attribute comprises a total connection score, said total connection score being determined using following formula:
total connection score=Σ(score for assumption connection, if ≧6);
(score for expectation connection if ≧6 and score for assumption connection ≧6);
(score for enhancement connection if ≧7 and score for expectation connection ≧6 and score for assumption connection ≧6);
(score for transformation connection if ≧7 and score for enhancement connection, if ≧7, score for expectation connection, if ≧6 and score for assumption connection, if ≧6).
